(19) United States
(12) Patent Application Publication
(10) Pub. No.: US 2011/0097548 A1
(43) Pub. Date: Apr. 28, 2011

(54) Multilayer Film

(76) Inventors: Mohan Harakchand Bhandari, Pune (IN); Praful Ramchandra Naik, Honavar (IN); Ajith Shashidharan, Pune (IN); Sanjeev Kulkarni, Kalyan (IN); Shrikant Bhagwat, Pune (IN); Sudhir Naik, Aurangabad (IN); Anirudha Sant, Baramati (IN); Ganesh Gudsoorkar, Aurangabad (IN)

(21) Appl. No.: 13/000,992

(22) PCT Filed: Dec. 19, 2008
(86) PCT No.: PCT/IN2008/000849

§ 371 Date: Dec. 22, 2010

(30) Foreign Application Priority Data
Jun. 24, 2008 (IN) 1318/MUM/2008

(51) Int. Cl. B32B 15/08; B32B 27/08; B65D 65/40; B44C 3/08

(52) U.S. Cl. 428/164; 428/172; 156/219

(57) ABSTRACT

A multilayered formable packaging film and a method of manufacturing the film are disclosed. The film is suitable for making blisters either by thermoforming or cold forming. The visible surface of the film has unique features preventing counterfeiting, which features are retained on the film even after blister formation. The film has a thickness not exceeding 1050 microns. The film substrate has a 10-500 micron thickness, is devoid of plasticizer and comprises at least one polymeric resin. A coat of an ester acrylic based primer having a 0.1-1 micron thickness is on a first surface of the substrate. A metallized layer with non-uniform thickness between 0.001 to 0.3 micron is deposited on the coat and embossed. A base having a thickness of 50-1000 microns is on the second surface, the base comprising at least one polymeric resin.

### FIELD OF THE INVENTION

The present invention relates to a multi-layer film.

Particularly, the present invention relates to multi-layer films suitable for use in the packaging industry.

### BACKGROUND OF THE INVENTION

Today, a significant fraction of healthcare products and variety of other products including consumable products and non edible products are packed in blisters. Amongst many other advantages, blister packaging offers convenience in terms of portability and also helps to protect a packaged drug over longer shelf life.

In this specification the use of the term ‘film’ refers either to an element having one or more layers applied or formed one over the other; or an element where different layers or lamina are joined together by a bonding process, therefore a laminate; or a combination in which some layers are formed or applied and some are bonded.

Blister packaging has proven to be a highly effective and successful packaging form for the pharmaceutical industry. It instills confidence regarding the quality and purity of a product, it protects every unit dose till it is consumed, once each unit is accessed only when required for consumption. At the same time, it also provides the manufacturer with a surface upon which information may be provided to the consumer.

Blisters can be formed by thermoforming or cold forming process.

Counterfeiting is a severe problem for all industries including the pharmaceutical industry. Legitimate businesses are losing millions due to counterfeit activity. The International chamber of commerce estimates that US$900 Billion are lost by businesses worldwide due to counterfeit products. This translates to 10-30% of the sales being lost to counterfeiters, forgers and duplicators. In some countries the figure in percentage is much higher.

Counterfeiting is the fastest growing crime in the world. Studies suggest that consumers would prefer to buy products that are in tamper evident authenticated packaging so as to reduce the chance of buying imitation products.

However, with the growing counterfeiting problem that the pharmaceutical industry has to tackle (research by the World Health Organization shows that approximately 5% of the world's medicines are counterfeit, and in some areas this percentage can be as high as 50%), Every leading brand is prone to be attacked by unscrupulous individuals. Counterfeiters not only copy the leading brand, but can also permanently damage its reputation. It is the responsibility of the manufacturer or brand owner to ensure that a genuine unadulterated product reaches the consumer.

Blister packaging, which is prone to counterfeiting, appears to be losing its “sheen”. It can be a viable proposition if it evolves such that it is impossible for a counterfeiter to duplicate.

The Indian patent application 1131/DEL/2006 relates to a process for making a colored hologram using lacquer based UV or electron beam cured resin as embossing surface on a plastic or paper substrate where the preformed embossed images on the master roller is transferred to the radiation curing resins. The resins are selected from acrylic or methacrylate based compounds. The patent application 1131/DEL/2006 essentially relates to a formation of holographic image on a flexible film via flexographic printing machine where the resin is applied on the plastic or paper substrate and then the preformed holographic image is transferred from the master to the flexible plastic or paper substrate followed by radiation curing of the resin on the selected holographic image areas.

Objects

It is an object of the present invention to provide a multilayered formable film for packaging of pharmaceutical products, edible products and non edible products.

It is another object of the present invention to provide a packaging film or laminate which will help against counterfeiting.

It is yet another object of this invention is to provide a packaging film which will act as a protective authentication and by which a lay person can easily identify the product at a display counter and distinguish it from a fake.

### DEFINITIONS

The term “film” in the context of the present invention includes single layered or multilayered films and or a laminate.

The term “Pharmaceutical” as used in the present text shall be deemed to include a medicine, a drug, a food supplement, a confectionery, a neutraceutical or a healthcare product in any form including a tablet, a blister, a pastille or any other product for packaging of pharmaceutical.

The term “edible” as used in the present text shall be deemed to include any substance that can be eaten without harm, non-toxic to humans or suitable for consumption.

The term “non-edible” as used in the present text shall be deemed to include any substance that can not be used as a food.

The term “coating” as used in the present text includes applying, layering and pressing or deposition of metal compound by vacuum evaporation process and also includes coating be a lacquer or a polymer.

The term “thermoforming process” as used in the context of the present invention means a manufacturing process for thermoplastic sheet or film wherein plastic sheet or film is converted into a formed, finished part. The sheet or film is heated in an oven to its forming temperature followed by stretching into or onto a mold.

The term “coldforming process” as used in the context of the present invention means a manufacturing process in which material is shaped at ambient temperature to produce material components with a close tolerance and net shape.

### SUMMARY OF THE INVENTION

In accordance with this invention there is provided a multilayer formable packaging film of total thickness not exceeding 1050 microns comprising
a substrate of thickness between 10 to 1000 microns, that is devoid of plasticizer,
a coat of an ester acrylic based primer of thickness in the range of 0.1 to 1 micron, on first surface of said substrate,
a metallized layer of non-uniform thickness between 0.001 to 0.3 micron deposited on said coat and embossed with a pre-determined pattern; and
a base of thickness between 50 to 1000 micron provided on the second surface of said substrate.

Typically, multilayer formable packaging film as prepared in accordance with the present invention is either thermoformable or coldformable.

Typically, said substrate comprises at least one polymeric resin selected from a group of resins consisting of polyvinyl chloride (PVC), Polypropylene (PP), Polyethylene (PE) and polyethylene terephthalate copolymerized with glycols (PETg), polyester, polyamide, polystyrene, copolymer of polystyrene and EVOH.

In accordance with a preferred embodiment of the invention the substrate comprises a polyvinyl chloride film having vinyl monomer content less than 1 ppm and a global migration of additives of less than 60 ppm.

Typically, the substrate is selected from a group of substrates consisting of a transparent substrate, a translucent substrate and an opaque substrate.

Typically, the substrate has at least one layer. In accordance with one preferred embodiment of the invention the substrate is colored. In accordance with another preferred embodiment of the invention, the substrate is multilayered and at least one of the layers is colored.

Typically, the metallized layer comprises at least one 99% pure metal selected from a group consisting of aluminum, gold, silver, copper and platinum. Alternatively, the metallized layer comprises 99% pure metal compound selected from a group consisting of Zinc oxide (ZnO), Zinc Sulphide (ZnS), SiO2 and SiOₓ₋ₙNₙ.

Typically, the metallization of the substrate is achieved by improving the adhesion of metal layer or metal compound layer Improvement in the adhesion of the metal or metal compound layer is achieved by applying a specially developed acrylic based primer coat of thickness 0.1 to 1 microns. Typically, specially developed primer assures the adhesion of the metal or metal compound layer as well as it also helps to improve the stability of the metal or metal compound layer after embossing treatment using a differential grating pattern. This layer also helps to improve display of the embossed pattern.

Typically, the base is selected from a group consisting of a transparent base, a translucent base and an opaque base. Typically, the base contains at least one layer. In accordance with one preferred embodiment of the invention, the substrate and the base are integral and monolithic. In accordance with still another preferred embodiment of the invention, the substrate and the base are integral and multilayered.

Typically, said base comprises at least one layer of a polymeric resin selected from a group of resins consisting of polyvinyl chloride, polypropylene, polyethylene and polyethylene terphthalate copolymerized with glycols (PETg), polyester, polyamide, polystyrene, copolymer of polystyrene and EVOH.

Typically, the base is multilayered and one of the layers of the multilayered base is pigmented.

Typically, the film includes at least one colored or colorless lacquer layer having thickness of 0.5 to 8 microns applied between the substrate and the coat, between the coat and the metallized layer or above the metallized layer.

In accordance with a preferred embodiment of this invention, the multilayer formable film includes a polymeric layer of thickness in the range of 0.5 to 250 microns, which has at least one property from a group of properties consisting of moisture barrier, oxygen barrier, gas barrier, or vapor barrier properties, said polymeric layer being located at least at one location operably within the substrate, on the substrate and below the coat, or below the substrate or on the metallized layer or within the base.

In accordance with still further embodiment of the invention the multilayer formable film includes an anti-scuffing layer of thickness 0.5 to 250 microns is provided on the top of the metallized layer. Typically, the anti-scuffing layer comprises anti-scuffing material selected from a group consisting of silica, molybdenum sulfide, graphite and iron oxide.

Typically, the embossed pattern is selected from a group consisting of graphic pattern and textual pattern, wherein the graphic pattern is at least one selected from a group consisting of diamond pattern, a broken glass pattern, a rainbow pattern, a dot pattern, a square pattern, a honey comb pattern, a flower pattern, a triangular pattern, a wavy line pattern, a star burst pattern; a circular pattern, striation pattern and an image pattern.

In accordance with this invention there is also provided a process for preparation of a multilayer formable packaging film of total thickness not exceeding 1050 microns comprising the following steps:
selecting a pharmaceutical grade polymeric film substrate of thickness in the range of 10 to 1000 microns that is devoid of plasticizers;
applying a coat of an ester acrylic based primer having thickness in the range of 0.1 to 1 micron on a first surface of the substrate;
partially drying the coat;
depositing a metallized layer on the partially dried coat;
embossing the metallized layer with a shim to form an embossed pattern thereon and make the thickness of the metallized layer non uniform; and
providing a polymeric base of thickness in the range of 50 to 1000 microns on the second surface.

Typically, the process for preparation of a multilayer formable packaging film in accordance with this invention includes the step of applying a lacquer coat either on the substrate or on the coat or over the metallized layer.

Typically, the process for preparation of a multilayer formable packaging film in accordance with this invention includes a step of forming the substrate by laminating at least two films together by solvent based adhesive lamination technique, thermal bonding or co extrusion and dry adhesion.

Typically, the process for preparation of a multilayer formable packaging film in accordance with this invention includes the step of laminating the base either before or after the embossing step.

Typically, the process for preparation of a multilayer formable packaging film in accordance with this invention includes the step of heating the shim between 90 to 150° C. and applying the heated shim to the metallized layer deposited film to form an embossed pattern and immediately cooling the film with a pattern embossed thereon to around 20° C. In accordance with a preferred embodiment of the invention, the process for preparation of a multilayer formable packaging film includes the step of providing anti-scuffing layer on the embossed metallized layer.

In accordance with the present invention there is also provided a package made by thermoforming or cold forming the multilayered forming packaging film of the present invention.

The multilayer formable non uniform embossed film may be coated with a suitable adhesive selected from the group of Polyurethanes, Waterborne acrylic dispersion-type coatings, UV-curable formulations, and unsaturated polyesters (peroxide cured).

In accordance with this invention there is also provided a multilayer formable non uniform embossed film in which base includes aluminum foil having thickness of about 20 to 150 microns sandwiched between two polymeric films to form a metal polymer based laminate and adhesive layer having thickness of about 2 to 8 microns for bonding the metal polymer based laminate to other layers in the base or to the substrate.

Typically, adhesive for bonding the metal polymer laminate to other layers in the base or to the substrate is selected from a group consisting of polyurethane, acrylic polymer, isocyanides and combination thereof.

In accordance with this invention there is also provided a process for preparation of a multilayer formable packaging film of total thickness not exceeding 1050 microns comprising the following steps:
selecting a substrate of thickness in the range of 10 to 1000 microns that is devoid of plasticizers;
applying a coat of an ester acrylic based primer having thickness in the range of 0.1 to 1 micron on a first surface of the substrate;
partially drying the coat;
depositing a metallized layer on the partially dried coat;
embossing the metallized layer with a shim to form an embossed pattern thereon and make the thickness of the metallized layer non uniform;
providing a base of thickness in the range of 50 to 1000 microns in which aluminum foil is sandwiched between two polymeric films;
applying adhesive layer having thickness of about 2 to 8 microns to the base; and
attaching the base to the substrate.

### BRIEF DESCRIPTION OF ACCOMPANYING DRAWINGS

The accompanying figures, which are incorporated in and constitute a part of this specification, illustrates several embodiments and together with the description serve to explain the principles of the invention.

FIG. 1a shows an opaque multilayered flat film laminate with differential grated nonuniform embossed pattern with text. The multilayered laminate was produced by metallizing the substrate followed by lamination of the substrate with a base (Thermoformable pre metallized laminate);

FIG. 1b shows an opaque blister pack made from the laminate as shown in FIG. 1a;

FIG. 2a shows an opaque multilayered flat film laminate with differential grated nonuniform embossed pattern with text. The multilayered laminate was produced by laminating the substrate and base followed by metallization of the substrate (Thermoformable post metallized laminate);

FIG. 2b shows an opaque blister pack made from the film laminate as shown in FIG. 2a;

FIG. 3a shows a transparent multilayered film laminate with differential grated nonuniform embossed pattern with text. The multilayered laminate was produced by metallizing the substrate followed by lamination of the substrate with base (Thermoformable pre metallized laminate);

FIG. 3b shows a transparent blister pack made from the laminate film as shown in FIG. 3a;

FIG. 4a shows a transparent multilayered film laminate with differential grated nonuniform embossed pattern with text. The multilayered laminate was produced by laminating the substrate and base followed by metallization of the substrate (Thermoformable post metallization laminate);

FIG. 4b shows a transparent blister pack made from the laminate as shown in FIG. 4a;

FIG. 5a shows an opaque multilayered film laminate with differential grated nonuniform embossed pattern with text. The multilayered laminate was produced by metallizing the substrate followed by lamination of the substrate with base (Cold formable pre metallized laminate);

FIG. 5b shows blister pack made from the laminate as shown in FIG. 5a;

FIG. 6a shows an opaque multilayered film laminate with differential grated nonuniform embossed pattern with text. The multilayered laminate was produced by metallizing the substrate followed by lamination of the substrate with base (Cold formable post metallized laminate); and

FIG. 6b shows blister pack made from the laminate of FIG. 6a.

### DETAILED DESCRIPTION OF THE INVENTION

In accordance with this invention there is provided a multilayer formable packaging film of total thickness not exceeding 1050 microns comprising
a substrate of thickness between 10 to 1000 microns, that is devoid of plasticizer,
a coat of an ester acrylic based primer of thickness in the range of 0.1 to 1 micron, on first surface of said substrate,
a metallized layer of non-uniform thickness between 0.001 to 0.3 micron deposited on said coat and embossed with a pre-determined pattern; and
a base of thickness between 50 to 1000 micron provided on the second surface of said substrate.

In accordance with the present invention, the multilayer formable packaging film is either thermoformable or coldformable.

The thickness of individual layer in the multi-layer formable film can vary depending on specific intended use and also on the ease of operation. It is found out that films made with thickness below 50 microns do not exhibit formable properties. Also films with thickness more than 1050 microns show very poor or no formable properties.

A wide variety of polymer films can be used for the formable film according to the present invention. Typical non-limiting examples of such film include polyvinyl chloride (PVC) film or high density polyethylene (HDPE) or low density polyethylene (LDPE) or polypropylene (PP) or amorphous polyethylene terephthalate (APET) co-polymer of PET with glycol (PETg), Polyethylene (PE) and polyethylene terephthalate polymerized with glycol (PETg), polyester, polyamide, polystyrene, copolymers of polystyrene and EVOH.

In accordance with a preferred embodiment of the invention the polymeric film substrate comprises a polyvinyl chloride film having vinyl monomer content less than 1 ppm and a global migration of additives less than 60 ppm.

Typically, the substrate has at least one layer.

Also, the multi-layer film may additionally comprise additional layers of polymer, resin or other substances, if desired. The substrate comprises one or more polymeric films which are bound by any one of processes such as dry adhesive, co-extrusion, wet lamination, dry-wet lamination, solvent based lamination and solvent less lamination. The lamination process may be effected by using different adhesives for example but not restricted to polyurethane, epoxy based, ionomers, oligomers, monomers, polyolefins based adhesives.

Typically, the base is selected from a group consisting of a transparent base, a translucent base and an opaque base. Typically, the base contains at least one layer. In accordance with one preferred embodiment of the invention, the substrate and the base are integral and monolithic. In accordance with still another preferred embodiment of the invention, the substrate and the base are integral and multilayered.

Typically, the base is multilayered and one of the layers of the multilayered base is pigmented. Typically, the film includes at least one colored or colorless lacquer layer having thickness of 0.5 to 8 microns applied between the substrate and the coat, between the coat and the metallized layer or above the metallized layer.

In accordance with a preferred embodiment of this invention, the multilayer formable film in accordance with this invention includes a polymeric layer of thickness in the range of 0.5 to 250 microns, which has at least one property from a group of properties consisting of moisture barrier, oxygen barrier, gas barrier, or vapor barrier properties, said polymeric layer being located at least at one location operably within the substrate, on the substrate and below the coat, or below the substrate or on the metallized layer or within the base.

In accordance with still further embodiment of the invention the multilayer formable film in accordance with this invention includes an anti-scuffing layer of thickness 0.5 to 250 microns is provided on the top of the metallized layer. Typically, the anti-scuffing layer comprises anti-scuffing material selected from a group consisting of silica, molybdenum sulfide, graphite, and iron oxide.

Typically, the embossed pattern is selected from a group consisting of graphic pattern and textual pattern, wherein the graphic pattern is at least one selected from a group consisting of diamond pattern, a broken glass pattern, a rainbow pattern, a dot pattern, a square pattern, a honey comb pattern, a flower pattern, a triangular pattern, a wavy line pattern, a star burst pattern; a circular pattern, a striation pattern and a image pattern.

In accordance with this invention there is also provided a process for preparation of a multilayer formable packaging film of total thickness not exceeding 1050 microns comprising the following steps:
selecting a substrate of thickness in the range of 10 to 1000 microns that is devoid of plasticizers;
applying a coat of an ester acrylic based primer having thickness in the range of 0.1 to 1 micron on a first surface of the substrate;
partially drying the coat;
depositing a metallized layer on the partially dried coat;
embossing the metallized layer with a shim to form an embossed pattern thereon and make the thickness of the metallized layer non uniform; and
providing a base of thickness in the range of 50 to 1000 microns on the second surface.

The selected pharmaceutical grade polymeric film is further coated with special primers like ester acrylic based, urethane-acrylate based and urethane-isocynide based primers, typically by a gravure coating process. The primer coated multilayered film is then metalized with 99% pure metals or metals compounds. Metal compounds that are used for metallized layer formation include Zinc oxide (ZnO), Zinc Sulphide (ZnS), SiO₂, and SiOₓ₋ₙNₙ, Various pure metals compounds are also used for providing the metallized layer which includes aluminum, gold, silver, copper and platinum. Metals or metal compounds are deposited on the substrate by a vacuum evaporation/deposition technique. Prior to metallic compound coating the film and/or film may be treated with plasma to achieve better adhesion of the said metal layer with the polymeric substrate. Alternatively, the non uniform embossed metal layer coated film is initially coated with suitable primer for assuring uniform coating and proper adhesion of the metal on the polymeric film during vacuum evaporation. The metallized formable film is then subjected to differential grating non uniform embossing with a desired art work and design. Pre-designed diffraction grating patterns are produced on the said multilayered film by embossing the film with a computerized laser cut shim by thermal embossing technique. A ‘shim’ is a cylindrical shell, typically of nickel on which a pattern is etched or formed, typically by laser. The shim is mounted on a cylinder which is hollow in nature & filled with oil. The oil is heated from 90 to 150 degree Celsius and the shim is pressed on a film by which a pattern is embossed in the form of graphics and design on a substrate.

The differential grating embossing produces a surface which has metallized particles in a layer which has uneven or non uniform thickness. This unevenness causes light incident thereon to be refracted causing a shimmer of images and causing the incident light to be broken up into colors as if prismatically. By selecting an appropriate pattern for embossing a specific refraction/diffraction effect is created on the metalized surface. The effect may further be enhanced by colorization of one or more of the layers on which the metallic compound coating is done and by selecting specific metal compound particles. The variety of effects can include forming readable brands or logos visible when the film is viewed at a particular angle or kaleidoscopic 3 dimensional patterns or images. These effects are retained in the film particularly even after the film or laminate has been thermoformed or cold formed to form a blister pack not only on the flat surface but also on the formed both cavities on the domes and side walls for example of the blisters giving an overall sheen and selective refractive shimmer to the film to produce a surface with a predetermined recognizable unique refractive effect. This effect will make the film and the product such as a pharmaceutical product and non edible products packed in the film or laminate not ‘counterfeitable’.

In accordance with one preferred embodiment of the invention the substrate is colored. In accordance with another preferred embodiment of the invention, the substrate is multilayered and at least one of the layers is colored. Coloring of the metallized layer can be done to obtain a coloured film with a non-uniform embossable metallazied layer. To achieve coloration, the metallized film can be coated with a desired colour and have a lacquer of thickness 0.5 to 1.5 gsm. The application of the colored lacquer can be done before the deposition of metallized layer or after the deposition of the metallized layer.

The process in accordance with this invention includes the step of applying a layer having at least one property selected from a group of properties consisting of moisture barrier properties, oxygen barrier properties, gas barrier properties, and vapor barrier properties within the base, below the base, between the base and the substrate or within the substrate. The multi-layered formable film may be further top coated with an anti-scuffing coat selected from a group of materials consisting of SiO₂, Molybdenum sulphide, Graphite and iron oxide to prevent scuffing of the embossed metallized surface.

A wide variety of adhesives can be advantageously used according to the present invention. Preferably, the adhesive comprises a polymeric substance capable of undergoing polymerization at higher temperatures. The multilayer formable non uniform embossed film may be coated with a suitable adhesive selected from the group of Polyurethanes, Waterborne acrylic dispersion-type coatings, UV-curable formulations, and unsaturated polyesters (peroxide cured).

The adhesive coat can be applied by several methods typically known to a person skilled in the art and includes coating and spraying. Before coating adhesive to the first surface of the rigid polymeric substrate, the rigid formable polymeric film can be pretreated, to impart uniformity or improve the adhesion of the coated material. The wet adhesive coat is then pressed with the desired polymer film to form the substrate. If desired, the adhesive coat may be partially dried. Such partial drying at elevated temperature removes volatile components. Once the desired polymer film is applied on the adhesive coat, say by pressing, the substrate may be further subjected to heat treatment. When the adhesive coat comprises a polymerizable substance, the curing of this polymerizable substance occurs through further polymerization, thereby imparting further adhesive strength. However, the post-heat treatment is optional and entirely depends on several parameters such as the nature of individual constituents and final properties desired.

Multi-layer film having a film which is metallized and embossed with a predetermined image or text and having non uniform thickness is laminated with the rigid formable polymeric base.

In accordance with this invention there is also provided a multilayer formable non uniform embossed film in which base includes aluminum foil having thickness of about 20 to 150 microns sandwiched between two polymeric films to form a metal polymer laminate and adhesive layer having thickness of about 2 to 8 microns for bonding the metal polymer laminate to other layers in the base or to the substrate.

In accordance with this invention there is also provided a process for preparation of a multilayer formable packaging film of total thickness not exceeding 1050 microns comprising the following steps:
selecting a substrate of thickness in the range of 10 to 1000 microns that is devoid of plasticizers;
applying a coat of an ester acrylic based primer having thickness in the range of 0.1 to 1 micron on a first surface of the substrate;
partially drying the coat;
depositing a metallized layer on the partially dried coat;
embossing the metallized layer with a shim to form an embossed pattern thereon and make the thickness of the metallized layer non uniform;
providing a base of thickness in the range of 50 to 1000 microns in which aluminum foil is sandwiched between two polymeric films;
applying the adhesive layer having thickness of about 2 to 8 microns to the base; and
attaching the base to the substrate.

A variety of adhesive in preparation of multilayered formable film, in accordance with present invention, for bonding the metal polymer laminate to other layers in the base or to the substrate is selected from a group consisting of polyurethane, acrylic polymer, isocyanides and combination thereof. The adhesives coat can be applied by several methods typically known to a person skilled in the art.

The multi-layer thermoformable and cold formable packaging films according to present invention have excellent bursting strength, barrier properties and deformation resistance. Advantageously, the film according to present invention has high abrasion resistance and also can withstand thermoforming/coldforming processes without any damage to non uniform thickness embossed design during the process of forming the film in to blisters packaging. An anti scuffing anti abrasive layer can be advantageously provided on the metalized layer. Preferably such a layer may contain silica particles for increasing the anti scuffing effect. The silica particles may be applied typically, in the form of a lacquer layer.

The multilayered formable non-uniform embossed metallized film in accordance of the present invention can be an effective anti-counterfeiting measure.

From the foregoing description, it will thus be evident that the present invention provides novel formable multi-layer film with an embossed metallized layer of non uniform thickness.

The invention will now be described with reference to the accompanying examples

### Example 1

A 250 micron pharmaceutical grade PVC film devoid of plasticizer and having vinyl monomer content less than 1 ppm and global migration less than 60 ppm was selected of 600 mm width. A roll of this film was loaded on gravure coating machine. Ester-acrylic based primer HT 07 XXX from Magma Polymers Private Limited with viscosity of 26 to 32 sec. was applied on one surface of the film using the gravure roller and extra primer was removed by doctoring process. 0.8 microns thick coating of this primer was achieved by adjusting the roller gap & doctor blade angle. Then this coated film was allowed to travel through on-line ovens via a conveyer. The oven temperature was set at a temperature of 75° C. and the speed of 30 m/min for drying the primer on the film. The drying of the primer on the film was confirmed by non tackiness and by non-blocking of the said film at the rewinder roller.

The two layer film formed by the above process was then transferred to a metallizer unit. This unit had an in situ plasma generation device and was fitted with an evaporation boat in which material [Zinc Sulphide] to be deposited was placed. The primer coated surface of the film was treated by plasma and thereafter deposited with Zinc Sulfide having 99.99% purity. Thickness of this deposited layer was 0.025 microns. The thickness was achieved by adjusting the speed, height of the gun and the vacuum level in the metallizer unit.

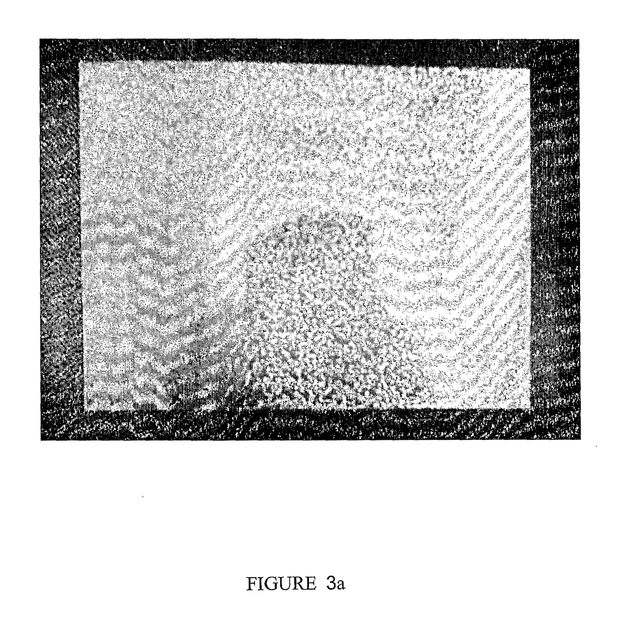

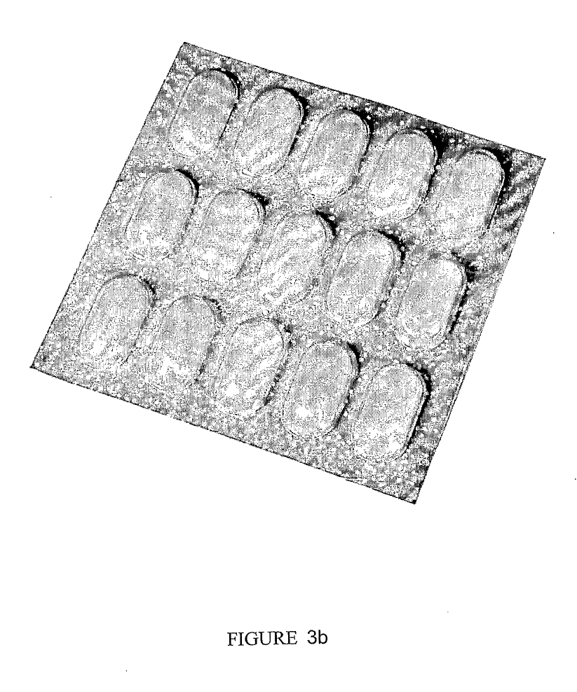

This three layer film was exposed to a differential embossing grating process. A custom built machine was used for the embossing process. A diamond patterned shim was mounted on the roller which was preheated to a temperature of 130 to 150 degree Celsius. Movement of the shim with pressure on the metalized surface transferred the uneven impression of the pattern on metalized side of the said three layer film. This film there after was cooled down to 20 degree Celsius by passing over a chilled roller to fix the differential grating pattern. The shim made for the above purpose was cut with a grating pattern by using computerized laser cutting mechanism. A film with a refractive surface showing a differential grating pattern was produced. The formed transparent multilayered flat film laminate with differential grated nonuniform embossed pattern is illustrated in FIG. 3a.

Blisters packs were formed from this multilayered film by a thermoforming process which showed excellent thermoforming performance with fine diffraction grating pattern even after the thermoforming process as shown in FIG. 3b.

Specification of the film was as follows:

| Total thickness | | about 251 micron | |
|---|---|---|---|
| Adhesion of embossed pattern with scotch tape test: | | passes | |
| Thermoforming performance | | Excellent | |
| Impact strength | | 953 | g |
| Tensile strength | - Longitudinal | 5.11 | kg/cm2 |
| | -Transverse | 4.88 | Kg/cm2 |

| | | |
|---|---|---|
| Elongation | - Longitudinal | 5% |
| | -Transverse | 4.8% |

| | | |
|---|---|---|
| Heat seal strength | 0.65 | kg/cm |
| WVTR of the blister | 8 | g/m2/day |

### Example 2

A film was produced as per the example 1 except thickness of the PVC film used was 120 microns and the film was embossed with a rain-bow pattern. The three layer film demonstrated the following properties

| Total thickness | | about 121 micron | |
|---|---|---|---|
| Adhesion of embossed pattern with scotch tape test: | | passes | |
| Thermoforming performance | | Excellent | |
| Impact strength | | >950 | g |
| Tensile strength | Longitudinal | 21.11 | kg/cm2 |
| | Transverse | 20.96 | Kg/cm2 |

| | | |
|---|---|---|
| Elongation | Longitudinal | 6.8% |
| | Transverse | 6.9% |

| | | |
|---|---|---|
| Heat seal strength | 0.65 | kg/cm2 |

### Example 3

A film was produced as per example 1 except thickness of the PVC film used was 35 microns and the film was embossed with broken glass pattern. The three layer film demonstrated the following properties

| Total thickness | | about 36 micron | |
|---|---|---|---|
| Adhesion of embossed pattern with scotch tape test: | | passes | |
| Thermoforming performance | | poor | |
| Impact strength | | 200 | g |
| Tensile strength | Longitudinal | 1.78 | kg/cm² |
| | Transverse | 1.65 | kg/cm² |

| | | |
|---|---|---|
| Elongation | Longitudinal | 3.2% |
| | Transverse | 2.7% |

| | | |
|---|---|---|
| Heat seal strength | 0.60 | kg/cm |

### Example 4

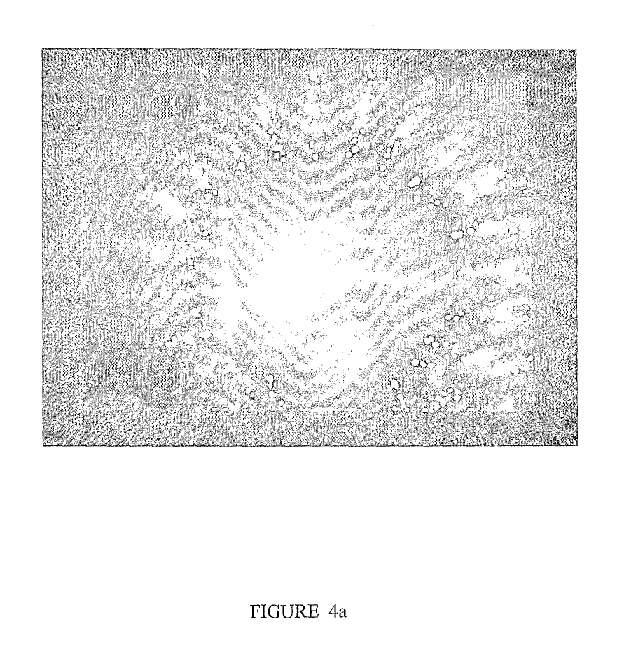

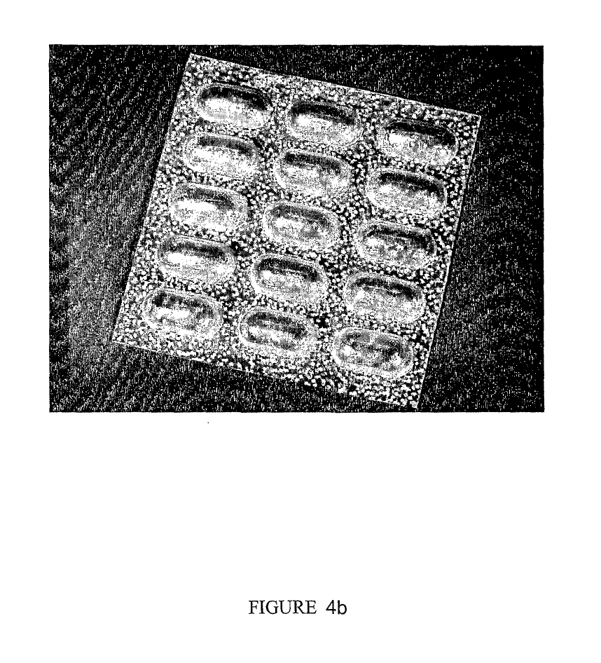

A 250 micron pharmaceutical grade PVC film devoid of plasticizer and having vinyl monomer content less than 1 ppm and global migration less than 60 ppm, was laminated with 120 micron pharmaceutical grade PVC film roll devoid of plasticizer and having vinyl monomer content less than 1 ppm and global migration less than 60 ppm; by dry adhesion technology using polyurethane adhesive of 4 gsm. The adhesive suspension applied had a viscosity of 24 sec, and was dried at 75° at the machine speed 30 m/min This three layer laminated film was made to undergo primer coating, metallic compound & embossing with a differential grating pattern as per example 1. The formed transparent multilayered flat film laminate with differential grated nonuniform embossed pattern is illustrated in FIG. 4a. Blisters packs were formed from this multilayered film by a thermoforming process which showed excellent thermoforming performance with fine diffraction grating pattern even after the thermoforming process as shown in FIG. 4b.

The resultant multilayer film demonstrated the following properties.

| Total thickness | | about 376 micron | |
|---|---|---|---|
| Adhesive coat | | 4 | gsm |
| Adhesion of differentially grated | | passes | |
| laminated with scotch tape test: | | | |
| Thermoforming performance | | Excellent | |
| Impact strength | | >950 | g |
| Tensile strength | Longitudinal | 21.11 | kg/cm² |
| | Transverse | 20.96 | kg/cm² |

| | | |
|---|---|---|
| Elongation | Longitudinal | 6.8% |
| | Transverse | 6.9% |

### Example 5

A four layer substrate of 1050 micron thickness was made by laminating three 300 micron each & one 150 micron pharmaceutical grade PVC film devoid of plasticizer and having vinyl monomer content less than 1 PPM and global migration less than 60 PPM; by dry adhesion technology using polyurethane adhesive of 12 microns. The adhesive suspension applied had a viscosity of 24 sec, and was dried at 75° at the machine speed 30 m/min. This laminated film underwent primer coating of metallic compound & embossing with Square pattern as per example 1. The resultant multilayer film demonstrated the following properties.

| Total thickness | | 1066 | micron |
|---|---|---|---|
| Adhesive coat | | 12 | gsm |
| Adhesion of differentially grated | | passes | |
| laminated with scotch tape test: | | | |
| Thermoforming performance | | not possible | |
| Impact strength | | >900 | g |
| Tensile strength | Longitudinal | 50.66 | kg/cm² |
| | Transverse | 45.44 | kg/cm² |

| | | |
|---|---|---|
| Elongation | Longitudinal | 8.5% |
| | Transverse | 7.6% |

### Example 6

A film was produced as example 1 in which a blue coloured pigmented PVC film of thickness 120 microns was used and was embossed with flower like pattern. Resulting multilayered film demonstrated following properties:

| Total thickness | | 121 | micron |
|---|---|---|---|
| Adhesion of differentially grated | | passes | |
| laminated with scotch tape test: | | | |
| Thermoforming performance | | Excellent | |
| Impact strength | | >950 | g |
| Tensile strength | Longitudinal | 21.11 | kg/cm² |
| | Transverse | 20.96 | kg/cm² |

| | | |
|---|---|---|
| Elongation | Longitudinal | 6.8% |
| | Transverse | 6.9% |

### Example 7

A film was produced as per the example 1 except the polymeric film used was a co-polymer of polyethylene terepthalate and glycol (PETg) film and embossed with rain-bow pattern. The three layer film demonstrated the following properties

| Total thickness | | 251 | micron |
|---|---|---|---|
| scotch tape test: | | passes | |
| Thermoforming performance | | Excellent | |
| Impact strength | | >950 | g |
| Tensile strength | Longitudinal | 6.5 | kg/cm2 |
| | Transverse | 5.75 | Kg/cm2 |

| | | |
|---|---|---|
| Elongation | Longitudinal | 5.5% |
| | Transverse | 5.1% |

### Example 8

A film was produced as per example 1 except that cast polypropylene film was used as substrate having thickness of 300 microns and embossed with a diamond pattern. The three layer film demonstrated the following properties

| Total thickness | | about 301 micron | |
|---|---|---|---|
| scotch tape test: | | passes | |
| Thermoforming performance | | Excellent | |
| Impact strength | | >350 | g |
| Tensile strength | Longitudinal | 2.36 | kg/cm2 |
| | Transverse | 2.2 | Kg/cm2 |

| | | |
|---|---|---|
| Elongation | Longitudinal | 11.2% |
| | Transverse | 11% |

### Example 9

A 35 micron pharma grade PVC film was laminated with 300 micron thick cast polypropylene film by using polyurethane based adhesive of thickness 5 microns with the help of gravure coating process and made to undergo primer coating, metallic compound coating and embossing with rain bow pattern with text as per example 4. The resulting film demonstrated the following properties

| Total thickness | | about 341 micron | |
|---|---|---|---|
| scotch tape test: | | passes | |
| Thermoforming performance | | Excellent | |
| Impact strength | | >953 | g |
| Tensile strength | Longitudinal | 17.39 | kg/cm2 |
| | Transverse | 16.78 | Kg/cm2 |

| | | |
|---|---|---|
| Elongation | Longitudinal | 6.4% |
| | Transverse | 6.5% |

### Example 10

A 100 micron thick PVC film was laminated with 250 micron thick co-polymer of polyethylene terepthalate and glycol (PETg) film by using polyurethane based adhesive of thickness 5 microns with the help of gravure coating process and embossed with broken glass pattern as per example 10. The resulting film demonstrated the following properties

| Total thickness | | about 356 micron | |
|---|---|---|---|
| scotch tape test: | | passes | |
| Thermoforming performance | | Excellent | |
| Impact strength | | >953 | g |
| Tensile strength | Longitudinal | 17.39 | kg/cm2 |
| | Transverse | 16.78 | Kg/cm2 |

| | | |
|---|---|---|
| Elongation | Longitudinal | 6.4% |
| | Transverse | 6.5% |

### Example 11

A four layer 255 micron pharmaceutical grade PVC film with embossed pattern of diamond & text was produced as per example 1 in which a golden color lacquered of 4 micron thickness was applied prior to the primer coating. Blisters were formed from this film by thermoforming process which showed excellent thermoforming performance and showed the fine diamond diffraction grating pattern with text even after thermoforming process. The film exhibited the following properties,

| Total thickness | | about 260 micron | |
|---|---|---|---|
| scotch tape test: | | passes | |
| Thermoforming performance | | Excellent | |
| Impact strength | | 953 | g |
| Tensile strength | Longitudinal | 5.11 | kg/cm2 |
| | Transverse | 4.88 | Kg/cm2 |

| | | |
|---|---|---|
| Elongation | Longitudinal | 5% |
| | Transverse | 4.8% |

| | | |
|---|---|---|
| Heat seal strength | 0.65 | kg/cm |

### Example 12

A 250 micron pharmaceutical grade PVC film was produced with diamond embossed pattern as per example 1 in which the primer was tinted with green pigment. Blisters were formed from this film by thermoforming process which showed excellent thermoforming performance and showed the fine diamond diffraction grating pattern a green halo even after the thermoforming process. The film exhibited the following properties,

| Total thickness | | about 251 micron | |
|---|---|---|---|
| scotch tape test: | | passes | |
| Thermoforming performance | | Excellent | |
| Impact strength | | 953 | g |
| Tensile strength | Longitudinal | 5.11 | kg/cm2 |
| | Transverse | 4.88 | Kg/cm2 |

| | | |
|---|---|---|
| Elongation | Longitudinal | 5% |
| | Transverse | 4.8% |

| | | |
|---|---|---|
| Heat seal strength | 0.65 | kg/cm |

### Example 13

A 250 micron PVC film underwent PVDC coating of thickness of 40 gsm and was further treated as per example one and was embossed pattern of broken glass, was on opposite side of the PVDC coating to enhance the barrier properties of the film. The film exhibited the following properties,

| Total thickness | | about 253 micron | |
|---|---|---|---|
| scotch tape test: | | passes | |
| Thermoforming performance | | Excellent | |
| Impact strength | | 953 | g |
| Tensile strength | Longitudinal | 5.11 | kg/cm2 |
| | Transverse | 4.88 | Kg/cm2 |

| | | |
|---|---|---|
| Elongation | Longitudinal | 5% |
| | Transverse | 4.8% |

| | | |
|---|---|---|
| Heat seal strength | 0.65 | kg/cm |
| WVTR | 0.1 | gm/cm2/day |

### Example 14

A 250 micron PVC film was produced with dot embossed pattern as per example 1, and coated with 1.5 micron of anti scuff silica based lacquer of 2 gsm at a printing station Specification of the film was as follows:

| Total thickness | | 252 | micron |
|---|---|---|---|
| Adhesion of embossed pattern with scotch tape test: | | passes | |
| Thermoforming performance | | Excellent | |
| Impact strength | | 953 | g |
| Tensile strength | Longitudinal | 5.11 | kg/cm2 |
| | Transverse | 4.88 | Kg/cm2 |

| | | |
|---|---|---|
| Elongation | Longitudinal | 5% |
| | Transverse | 4.8% |

| | | |
|---|---|---|
| Heat seal strength | 0.65 | kg/cm |
| WVTR of the blister | 8 | g/m2/day |

The film showed excellent anti scuffing and anti abrasive properties.

### Example 15

A film was produced as per example 1 except a layer of silicon dioxide having thickness 0.025 micons was deposited with the help of vacuum deposition technique on the primer coated PVC film of 250 microns thickness and the film was embossed with a rain-bow pattern. The three layer film demonstrated the following properties

| Total thickness | | about 254 micron | |
|---|---|---|---|
| Adhesion of embossed pattern with scotch tape test: | | passes | |
| Thermoforming performance | | Excellent | |
| Impact strength | | >950 | g |
| Tensile strength | Longitudinal | 21.11 | kg/cm2 |
| | Transverse | 20.96 | Kg/cm2 |

| | | |
|---|---|---|
| Elongation | Longitudinal | 6.8% |
| | Transverse | 6.9% |

| | | |
|---|---|---|
| Heat seal strength | 0.65 | kg/cm2 |

### Example 16

A 250 micron pharmaceutical grade PVC film devoid of plasticizer and having vinyl monomer content less than 1 ppm and global migration less than 60 ppm was selected of 600 mm width. A roll of this film was loaded on gravure coating machine. Ester-acrylic based primer HT 07 XXX from Magma Polymers Private Limited with viscosity of 26 to 32 sec. was applied on one surface of the film using the gravure roller and extra primer was removed by doctoring process. 0.8 microns thick coating of this primer was achieved by adjusting the roller gap & doctor blade angle. Then this coated film was allowed to travel through on-line ovens via a conveyer. The oven temperature was set at a temperature of 75° C. and the speed of 30 m/min for drying the primer on the film. The drying of the primer on the film was confirmed by non tackiness and by non blocking of the said film at the rewinder roller. The two layer film formed by the above process was then transferred to a metallizer unit. This unit had an in situ plasma generation device and was fitted with an evaporation boat in which material [aluminum] to be deposited was placed. The primer coated surface of the film was treated by plasma and thereafter deposited with aluminum metal having 99.99% purity. Thickness of this deposited layer was 0.025 microns. The thickness was achieved by adjusting the speed, height of the gun and the vacuum level in the metallizer unit. This three layer film was exposed to a differential embossing grating process. A custom built machine was used for the embossing process. A diamond patterned shim was mounted on the roller which was preheated to a temperature of 130 to 150 degree Celsius. Movement of the shim with pressure on the metalized surface transferred the uneven impression of the pattern on metalized side of the said three layer film. This film there after was cooled down to 20 degree Celsius by passing over a chilled roller to fix the diamond pattern. The shim made for the above purpose was cut with a diamond pattern by using computerized laser cutting mechanism. A film with a refractive surface showing a diamond pattern was produced. Blisters packs were formed from this multilayered film by a thermoforming process which showed excellent thermoforming performance with fine diamond diffraction grating pattern even after the thermoforming process. Specification of the film was as follows:

| Total thickness | | about 250.825 micron | |
|---|---|---|---|
| Adhesion of embossed pattern | | passes | |
| with scotch tape test: | | | |
| Thermoforming performance | | Excellent | |
| Impact strength | | 953 | g |
| Tensile strength | Longitudinal | 5.11 | kg/cm2 |
| | Transverse | 4.88 | Kg/cm2 |

| | | |
|---|---|---|
| Elongation | Longitudinal | 5% |
| | Transverse | 4.8% |

| | | |
|---|---|---|
| Heat seal strength | 0.65 | kg/cm |
| WVTR of the blister | 8 | g/m2/day |

### Example 17

A film was produced as per the example 16 except thickness of the PVC film used was 120 microns and the film was embossed with a rain-bow pattern. The three layer film demonstrated the following properties

| | |
|---|---|
| Total thickness | about 121 micron |
| Adhesion of embossed pattern with scotch tape test: | passes |
| Thermoforming performance | Excellent |
| Impact strength | >950 g |
| Tensile strength | |
| Longitudinal | 21.11 kg/cm2 |
| Transverse | 20.96 Kg/cm2 |
| Elongation | |
| Longitudinal | 6.8% |
| Transverse | 6.9% |
| Heat seal strength | 0.65 kg/cm2 |

### Example 18

A 250 micron pharmaceutical grade PVC film devoid of plasticizer and having vinyl monomer content less than 1 ppm and global migration less than 60 pp, was laminated with 120 micron pharmaceutical grade PVC film roll devoid of plasticizer and having vinyl monomer content less than 1 ppm and global migration less than 60 ppm; by dry adhesion technology using polyurethane adhesive of 4 gsm. The adhesive suspension applied had a viscosity of 24 sec, and was dried at 75° at the machine speed 30 m/min This two layer laminated film was made to undergo primer coating, metallization & embossing with a dot pattern as per example 16. The resultant multilayer film demonstrated the following properties.

| Total thickness | about 376 micron |
|---|---|
| Adhesive coat | 4 gsm |
| Adhesion of differentially grated laminated with scotch | passes |
| tape test: | |
| Thermoforming performance | Excellent |
| Impact strength | >950 g |
| Tensile strength | |
| Longitudinal | 21.11 kg/cm² |
| Transverse | 20.96 kg/cm² |
| Elongation | |
| Longitudinal | 6.8% |
| Transverse | 6.9% |

### Example 19

A film was produced as example 16 in which a blue coloured pigmented PVC film of thickness 120 microns was used and was embossed with flower like pattern. Resulting multilayered film demonstrated following properties:

| Total thickness | 120.85 micron |
|---|---|
| Adhesion of differentially grated laminated with scotch | passes |
| tape test: | |
| Thermoforming performance | Excellent |
| Impact strength | >950 g |
| Tensile strength | |
| Longitudinal | 21.11 kg/cm² |
| Transverse | 20.96 kg/cm² |
| Elongation | |
| Longitudinal | 6.8% |
| Transverse | 6.9% |

### Example 20

A film was produced as per example 16 except the polymeric film used was a co-polymer of polyethylene terepthalate and glycol (PETg) film and embossed with rain-bow pattern. The three layer film demonstrated the following properties

| Total thickness | 250.835 micron |
|---|---|
| scotch tape test: | passes |
| Thermoforming performance | Excellent |
| Impact strength | >950 g |
| Tensile strength | |
| Longitudinal | 6.5 kg/cm2 |
| Transverse | 5.75 Kg/cm2 |
| Elongation | |
| Longitudinal | 5.5% |
| Transverse | 5.1% |

### Example 21

A four layer 255 micron pharmaceutical grade PVC film with embossed pattern of diamond & text was produced as per example 16 in which a golden color lacquered of 4 micron thickness was applied prior to the primer coating. Blisters were formed from this film by thermoforming process which showed excellent thermoforming performance and showed the fine diamond diffraction grating pattern with text even after thermoforming process. The film exhibited the following properties,

| | |
|---|---|
| Total thickness | about 260 micron |
| scotch tape test: | passes |
| Thermoforming performance | Excellent |
| Impact strength | 953 g |
| Tensile strength | |
| Longitudinal | 5.11 kg/cm2 |
| Transverse | 4.88 Kg/cm2 |
| Elongation | |
| Longitudinal | 5% |
| Transverse | 4.8% |
| Heat seal strength | 0.65 kg/cm |

### Example 22

A four layer 255 micron pharmaceutical grade PVC film with embossed pattern of diamond & text was produced as per example 16 in which a golden colour lacquer of 4 micron thickness was applied over metallisation.

The blisters were formed from this film by thermoforming process showed excellent thermoforming performance and showed the fine diamond diffraction grating pattern with text even after thermoforming process.
Hence the film exhibits the following properties,

| | |
|---|---|
| Total thickness | 255 micron |
| scotch tape test: | passes |
| Thermoforming performance | Excellent |
| Impact strength | 953 g |
| Tensile strength | |
| Longitudinal | 5.11 kg/cm2 |
| Transverse | 4.88 Kg/cm2 |
| Elongation | |
| Longitudinal | 5% |
| Transverse | 4.8% |
| Heat seal strength | 0.65 kg/cm |

### Example 23

A 250 micron PVC film was produced with dot embossed pattern as per example 16, and coated with 1.5 micron of anti scuff silica based lacquer of 2 gsm at a printing station Specification of the film was as follows:

| | |
|---|---|
| Total thickness | 252 micron |
| Adhesion of embossed pattern with scotch | passes |
| tape test: | |
| Thermoforming performance | Excellent |
| Impact strength | 953 g |
| Tensile strength | |
| Longitudinal | 5.11 kg/cm2 |
| Transverse | 4.88 Kg/cm2 |
| Elongation | |
| Longitudinal | 5% |
| Transverse | 4.8% |
| Heat seal strength | 0.65 kg/cm |
| WVTR of the blister | 8 g/m2/day |

The film showed excellent anti scuffing and anti abrasive properties.

### Example 24

A 35 micron pharmaceutical grade PVC film devoid of plasticizer having 600 mm width was subjected to an unwinder of a gravure coating machine. Ester-acrylic based primer from Magma Polymers Private Limited having viscosity of 26 to 32 sec. was applied using the gravure roller to the PVC film and extra primer was removed by doctoring process. Deposition of this primer had a thickness of 0.8 microns. Then this film was allowed to travel through on-line ovens via a conveyer. The oven temperature was set at a temperature of 75° C. and the speed of 30 m/min for drying the primer on the film was maintained. The drying of the primer on the film was confirmed by non tackiness and by non blocking of the rewinding at the rewinder roller.

The two layer film formed above was then transferred to a vacuum deposition machine. This machine had an in situ plasma device and was fitted with an evaporation boat in which the aluminum to be deposited was placed. The primer coated surface of the laminated film was first treated with plasma and thereafter was deposited with the aluminium metal having 99.99% purity. Thickness of this deposited layer was 0.025 microns. The thickness was achieved by adjusting the speed, height of the gun and the vacuum level.

This three layer film was exposed to a differential embossing grating process. A custom built machine was used for the embossing process. The three layered film was placed on an unwinder of this custom made machine, the film was passed through the roller having temperature of 130 to 150° C. by which the film was softened. A diffraction grating pattern shim was pressed on the metallized side of the film to create a diffraction grating embossed effect on the film. The shim made for the above purpose was cut with a grating pattern by using a computerized laser cutting mechanism to avoid duplication of the pattern by any one else.

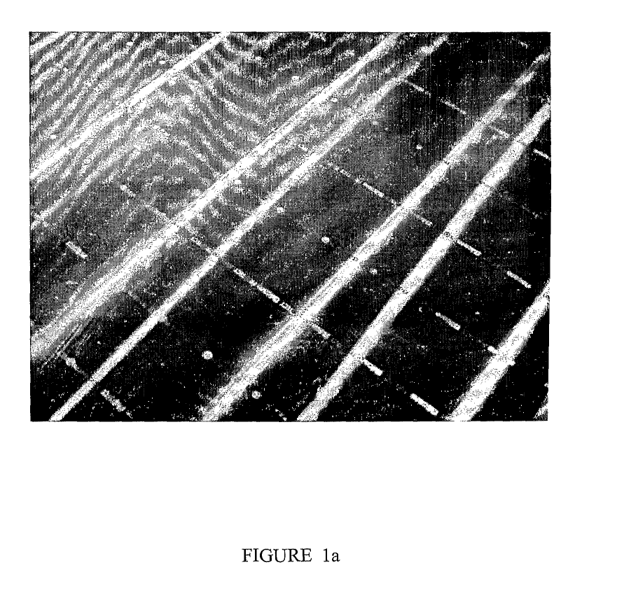

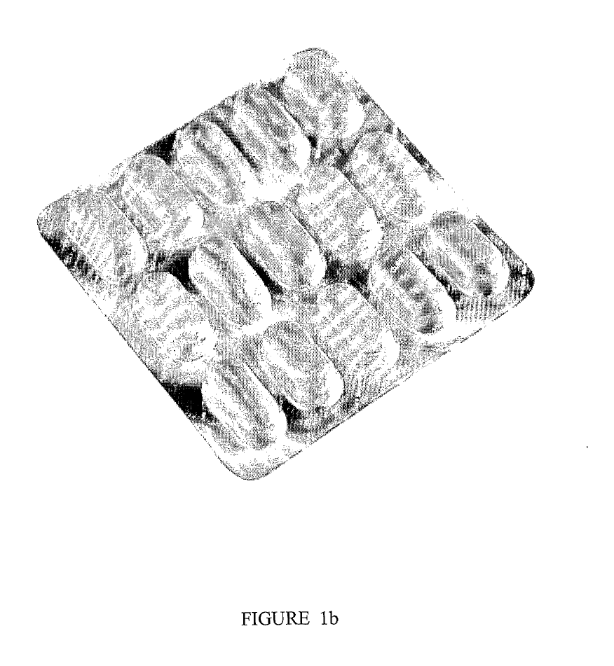

The other side of this film was then laminated to a 250 micron rigid PVC base by applying an adhesive between 3-6 gsm through the gravure lamination technique. The formed opaque multilayered flat film laminate with differential grated nonuniform embossed pattern with text is shown in FIG. 1a.

Blisters packs were formed from this laminate by the thermoforming process which showed excellent thermoforming performance and showed the fine non uniform embossed metallized pattern even after the thermoforming process as shown in FIG. 1b. Specification of the film was as follows:

| | |
|---|---|
| Total thickness | 287 micron |
| Adhesion of embossed pattern with | passes |
| scotch tape test: | |
| Thermoforming performance | Excellent |
| Impact strength | 955 g |
| Tensile strength | |
| Longitudinal | 13.5 kg/cm2 |
| Transverse | 13.7 Kg/cm2 |
| Elongation | |
| Longitudinal | 5.9% |
| Transverse | 5.8% |
| Heat seal strength | 0.65 kg/cm |
| WVTR of the blister | 8 g/m2/day |

### Example 25

A film was produced as per example 1 except thickness of the PVC film was 100 microns and pattern used for embossing was fine grains pattern and silver of purity 99.9 percent was used for metallization. The resulting multilayer film substrate was then laminated to a thermoformable, pharmaceutical grade PVC film of 250 microns devoid of plasticizer, using dry adhesion technology. Solvent based polyurethane adhesive of 4 gsm was applied to the latter PVC mono layer film by using gravure coating process. The adhesive suspension that was applied had a viscosity of 24 sec, and was dried at 75° at a machine speed of 30 m/min. The multilayer film demonstrated the following properties.

| Total thickness | 354 micron |
|---|---|
| Differentially grated laminated film thickness | 100 micron |
| Adhesive coat | 4 gsm |
| Adhesion to substrate & differentially grated | 200 gm/cm |
| laminated film | |
| Adhesion of differentially grated laminated | passes |
| with scotch tape test: | |
| Thermoforming performance | Excellent |
| Impact strength | >950 g |
| Tensile strength | |
| Longitudinal | 20.85 kg/cm² |
| Transverse | 20.6 kg/cm² |
| Elongation | |
| Longitudinal | 6.6% |
| Transverse | 6.7% |

### Example 26

A 35 micron thick thermoformable pharmaceutical grade gold pigmented PVC film with aluminium metal metallization layer thickness of 0.033 microns was made to undergo differential grating embossing procedure as per example 1 and further was laminated with a thermoformable pharmaceutical grade PVC film of thickness 300 microns with the help of polyurethane based adhesive coat via gravure coating process. The resultant film demonstrated the following properties

| Total thickness | about 340 micron |
|---|---|
| Gold tinted differentially grated laminated film | 35 micron |
| thickness | |
| Adhesive coat | 5 microns |
| Adhesion to substrate & differentially grated | 200 gm/cm |
| laminated film | |
| Adhesion of differentially grated laminated with | passes |
| scotch tape test: | |
| Thermoforming performance | Excellent |
| Impact strength | >950 g |
| Tensile strength | |
| Longitudinal | 15.1 kg/cm² |
| Transverse | 15.0 kg/cm² |
| Elongation | |
| Longitudinal | 6.2% |
| Transverse | 6.1% |

### Example 27

A laminate was produced as per example 1 except that the polymeric film was used from the class of co-polymer of polyethylene terepthalate and glycol (PETg) film having thickness 100 microns and pattern used for embossing was diamond pattern. The resultant laminate demonstrated the following properties

| | |
|---|---|
| Total thickness | 354 micron |
| Adhesion of non uniform embossed pattern with scotch | passes |
| tape test: | |
| Thermoforming performance | Excellent |
| Impact strength | 950 g |
| Tensile strength | |
| Longitudinal | 12.5 kg/cm2 |
| Transverse | 12.4 Kg/cm2 |
| Elongation | |
| Longitudinal | 5.9% |
| Transverse | 5.8% |
| Heat seal strength | 0.65 kg/cm |

### Example 28

A film was produced as per example 1 except that the thickness of the PVC film was 35 microns and the pattern used was a broken glass pattern. The three layer film was further laminated with a 300 micron thick cast polypropylene film by using polyurethane based adhesive of thickness 5 microns with the help of gravure coating process. The resulting laminate demonstrated the following properties

| Total thickness | 340 micron |
|---|---|
| Adhesion of non uniform embossed pattern with scotch | passes |
| tape test: | |
| Thermoforming performance | Excellent |
| Impact strength | >953 g |
| Tensile strength | |
| Longitudinal | 17.39 kg/cm2 |
| Transverse | 16.78 Kg/cm2 |
| Elongation | |
| Longitudinal | 6.4% |
| Transverse | 6.5% |

### Example 29

A 50 micron pharmaceutical grade PVC film roll devoid of plasticizer having 600 mm width was subjected to un winder of gravure coating machine. A coloured lacquer was then applied to this film having thickness of 4 micron with the help of gravure technology then after second pass the Ester-acrylic based special primer from Magma Polymers Private Limited having viscosity of 26 to 32 sec. was applied using gravure roller to this PVC film and extra primer was removed by doctoring process. Deposition of this primer had a thickness of 0.8 microns. Then this film was allowed to travel through on line ovens via a conveyer at a temperature of 75° C. at the speed of 30 m/min The drying of the film was ensured by non tacky and non blocking rewinding at the rewinder roller.

Thus the three layer laminate film formed above was then transferred to a vacuum deposition machine. This machine had an in situ plasma device and was fitted with an evaporating boat in which the material to be deposited was placed. The primer coated surface of above laminated film was first treated with plasma and thereafter deposited with a aluminium metal layer having 99.99% purity, thickness of this deposited layer was 0.020 microns. The thickness was achieved by adjusting the speed, height of gun and vacuum level.

Further, this four layer laminated film was exposed to differential embossing grating process. Custom made machine was used for embossing process. The four layered laminated film was then placed on un winder of this custom made machine, the film then was passed through a roller having temperature of 130 to 150° C. by which the film was softened, then diamond pattern shim was pressed on the metallized side of the laminate to create a diffraction grating on the film. The shim made for the above purpose was cut with a diamond pattern by using computerized laser cutting mechanism to avoid duplication of the pattern by any one else. Then this film was laminated to 200 micron PVC base devoid of plasticizer and having a vinyl chloride monomer concentration of less than 1 ppm and global migration less than 60 ppm.

Blister packs were formed from this film by thermoforming process which showed excellent thermoforming performance and showed a fine diamond non uniform embossed metallized pattern even after the thermoforming process. This laminate exhibited the following properties,

| | |
|---|---|
| Total thickness | 256 microns |
| Adhesion of non uniform embossed pattern with | passes |
| scotch tape test: | |
| Thermoforming performance | Excellent |
| Impact strength | 953 g |
| Tensile strength | |
| Longitudinal | 5.11 kg/cm2 |
| Transverse | 4.88 Kg/cm2 |
| Elongation | |
| Longitudinal | 5% |
| Transverse | 4.8% |
| Heat seal strength | 0.65 kg/cm |

### Example 30

A 50 micron pharmaceutical grade PVC film roll devoid of plasticizer having 600 mm width was subjected to the un winder of a gravure coating machine. Ester-acrylic based special primer from Magma Polymers Private Limited having viscosity of 26 to 32 sec. was applied using gravure roller to this PVC film and extra primer was removed by doctoring process. Deposition of this primer had thickness of 0.8 microns. Then this film was allowed to travel through in line ovens via a conveyer at a temperature of 75° C. at a speed of 30 m/min. The drying of the film was ensured by non tacky and non blocking rewinding at rewinder roller. Colour lacquer was then applied to this film with the help of the gravure. The thickness of the colour lacquer was about 0.4 microns.

Thus the three layer laminate film formed above was then transferred to a vacuum deposition machine. The primer coated surface of above laminated film was first treated with plasma and aluminium metal having 99.99% purity, thickness of this deposited layer was 0.1 micron. The thickness was achieved by adjusting the speed, height of gun and vacuum level. Further, this four layer laminated film was exposed to differential embossing grating process. Custom made machine was used for the embossing process. The three layered laminated film was then placed on un winder of this custom made machine, the film was passed through a roller having temperature of 130 to 150° C. by which the film was softened, then a diamond pattern shim was pressed on the metallized side of the laminate to create a diamond pattern on the film. Then this film was laminated as per Example 17.

Blister packs were formed from this film by a thermoforming process which showed excellent thermoforming performance and showed the fine diamond non uniform embossed metallized pattern even after thermoforming process. The laminate exhibited the following properties,

| | |
|---|---|
| Total thickness | 256 micron |
| Adhesion of non uniform embossed pattern with | passes |
| scotch tape test: | |
| Thermoforming performance | Excellent |
| Impact strength | 953 g |
| Tensile strength | |
| Longitudinal | 5.11 kg/cm2 |
| Transverse | 4.88 Kg/cm2 |
| Elongation | |
| Longitudinal | 5% |
| Transverse | 4.8% |
| Heat seal strength | 0.65 kg/cm |

### Example 31

A 50 micron pharmaceutical grade PVC film roll devoid of plasticizer having monomer content less than 1 ppm and global migration less than 60 ppm having 600 mm width was subjected to a un winder of gravure coating machine and laminated with 250 micron thick PVC film devoid of plasticizer having monomer content less than 1 ppm and global migration less than 60 ppm by dry adhesion technology using polyurethane based adhesive. This two layer film was coated with an ester-acrylic based special primer from Magma Polymers Private Limited having viscosity of 26 to 32 sec. was applied using gravure roller on surface of PVC film laminate where metallization to be carried out and extra primer was removed by doctoring process. Deposition of this primer had a thickness of 0.8 microns. This film was allowed to travel through in line ovens via a conveyer at a temperature of 75° C. at the speed of 30 m/min The drying of the film was ensured by non tacky and non blocking rewinding at rewinder roller.

Thus the three layer laminate film formed above was then transferred to a vacuum deposition machine. This machine had an in situ plasma device and was fitted with an evaporating boat in which the material to be deposited was placed. The primer coated surface of above laminated film was first treated with plasma and thereafter deposited with a aluminium metal layer having 99.99% purity, thickness of this deposited layer was 0.020 microns. The thickness was achieved by adjusting the speed, height of gun and vacuum level.

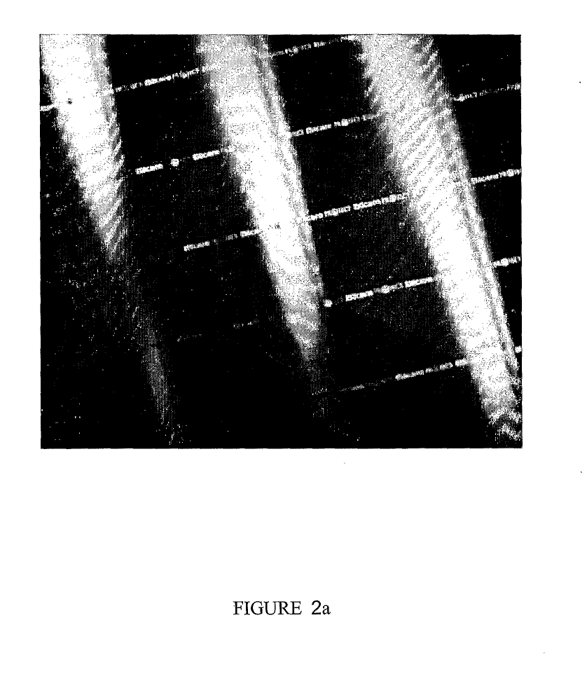

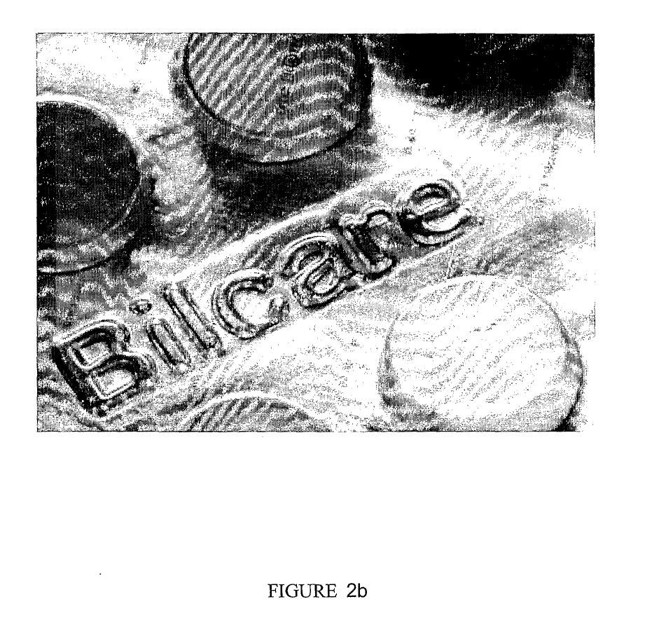

Further, this four layer film was exposed to a differential embossing grating process. Custom made machine was used for embossing process. The four layered laminated film was then placed on un winder of this custom made machine, the film then was passed through a roller having temperature of 130 to 150° C. by which the film was softened, then a differential grated pattern shim was pressed on the metallized side of film to create a diffraction grating pattern on the film. The shim made for the above purpose was cut with a diffraction pattern by using computerized laser cutting mechanism to avoid duplication of the pattern by any one else. The formed an opaque multilayered flat film laminate with differential grated nonuniform embossed pattern is illustrated in FIG. 2a.

Blister packs were formed from this film by thermoforming process which showed excellent thermoforming performance and showed the non uniform embossed metallized pattern even after the thermoforming process as shown in FIG. 2b. The laminate exhibited the following properties,

| | |
|---|---|
| Total thickness | 256 micron |
| Adhesion of non uniform embossed pattern with | passes |
| scotch tape test: | |
| Thermoforming performance | Excellent |
| Impact strength | 953 g |
| Tensile strength | |
| Longitudinal | 5.11 kg/cm2 |
| Transverse | 4.88 Kg/cm2 |
| Elongation | |
| Longitudinal | 5% |
| Transverse | 4.8% |
| Heat seal strength | 0.65 kg/cm |

### Example 32

A film was produced as per example 1 except thickness of the PVC film was 100 microns and pattern used for embossing was fine grains pattern and gold of purity 99.9 percent was used for metallization. The resulting multilayer film substrate was then laminated to a thermoformable, pharmaceutical grade PVC film of 250 microns devoid of plasticizer, using dry adhesion technology. Solvent based polyurethane adhesive of 4 gsm was applied to the latter PVC mono layer film by using gravure coating process. The adhesive suspension that was applied had a viscosity of 24 sec, and was dried at 75° at a machine speed of 30 m/min. The multilayer film demonstrated the following properties.

| Total thickness about | 354 micron |
|---|---|
| Differentially grated laminated film thickness | 100 micron |
| Adhesive coat | 4 gsm |
| Adhesion to substrate & differentially grated | 200 gm/cm |
| laminated film | |
| Adhesion of differentially grated laminated | passes |
| with scotch tape test: | |
| Thermoforming performance | Excellent |
| Impact strength | >950 g |
| Tensile strength | |
| Longitudinal | 20.85 kg/cm² |
| Transverse | 20.6 kg/cm² |
| Elongation | |
| Longitudinal | 6.6% |
| Transverse | 6.7% |

### Example 33

A 35 micron pharmaceutical grade PVC film devoid of plasticizer having 600 mm width was subjected to an unwinder of a gravure coating machine. Ester-acrylic based primer from Magma Polymers Private Limited having viscosity of 26 to 32 sec. was applied using the gravure roller to the PVC film and extra primer was removed by doctoring process. Deposition of this primer had a thickness of 0.8 microns. Then this film was allowed to travel through on-line ovens via a conveyer. The oven temperature was set at a temperature of 75° C. and the speed of 30 m/min for drying the primer on the film was maintained. The drying of the primer on the film was confirmed by non tackiness and by non blocking of the rewinding at the rewinder roller.

The two layer film formed above was then transferred to a vacuum deposition machine. This machine had an in situ plasma device and was fitted with an evaporation boat in which the material to be deposited was placed. The primer coated surface of the laminated film was first treated with plasma and thereafter was deposited with zinc silphide having 99.99% purity. Thickness of this deposited layer was 0.025 microns. The thickness was achieved by adjusting the speed, height of the gun and the vacuum level.

This three layer film was exposed to a differential embossing grating process. A custom built machine was used for the embossing process. The three layered film was placed on an unwinder of this custom made machine, the film was passed through the roller having temperature of 130 to 150° C. by which the film was softened. A diamond pattern shim was pressed on the metallized side of the film to create a diffraction grating embossed effect on the film. The shim made for the above purpose was cut with a diamond pattern by using a computerized laser cutting mechanism to avoid duplication of the pattern by any one else.

The other side of this film was then laminated to a 250 micron rigid PVC base by applying an adhesive between 0.5 to 8 microns through the gravure lamination technique. Blisters packs were formed from this laminate by the thermoforming process which showed excellent thermoforming performance and showed the fine diamond non uniform embossed metallized pattern even after the thermoforming process. Specification of the film was as follows:

| | |
|---|---|
| Total thickness | 287 micron |
| Adhesion of embossed pattern with | passes |
| scotch tape test: | |
| Thermoforming performance | Excellent |
| Impact strength | 955 g |
| Tensile strength | |
| Longitudinal | 13.5 kg/cm2 |
| Transverse | 13.7 Kg/cm2 |
| Elongation | |
| Longitudinal | 5.9% |
| Transverse | 5.8% |
| Heat seal strength | 0.65 kg/cm |
| WVTR of the blister | 8 g/m2/day |

### Example 34

A film was produced as per example 33 except thickness of the PVC film was 50 microns and pattern used for embossing was a rain-bow pattern. The three layer film was laminated to a 250 micron rigid PVC base. This laminate demonstrated the following properties

| | |
|---|---|
| Total thickness | 304 micron |
| Adhesion of embossed pattern with | passes |
| scotch tape test: | |
| Thermoforming performance | Excellent |
| Impact strength | >950 g |
| Tensile strength | |
| Longitudinal | 14.05 kg/cm2 |
| Transverse | 14.13 Kg/cm2 |
| Elongation | |
| Longitudinal | 6.2% |
| Transverse | 6.15% |
| Heat seal strength | 0.65 kg/cm2 |

### Example 35

A film was produced as per the example 34 in which a blue coloured pigmented 50 micron PVC film with text used for embossing with a flower like pattern. The resulting multilayered laminated demonstrated following properties:

| Total thickness | 304 micron |
|---|---|
| Differentially grated laminated film thickness | 50 micron |
| Adhesive coat | 4 microns |
| Adhesion to substrate & differentially | 200 gm/cm |
| grated laminated film | |
| Adhesion of differentially grated laminated | passes |
| with scotch tape test: | |
| Thermoforming performance | Excellent |
| Impact strength | >950 g |
| Tensile strength | |
| Longitudinal | 14.05 kg/cm² |
| Transverse | 14.13 kg/cm² |
| Elongation | |
| Longitudinal | 6.2% |
| Transverse | 6.15% |

### Example 36

A 35 micron thick thermoformable pharmaceutical grade gold pigmented PVC film with zinc sulphide metallization layer thickness of 0.033 microns was made to undergo differential grating embossing procedure as per example 33 and further was laminated with a thermoformable pharmaceutical grade PVC film of thickness 300 microns with the help of polyurethane based adhesive coat via gravure coating process. The resultant film demonstrated the following properties

| Total thickness | 340 micron |
|---|---|
| Gold tinted differentially grated laminated film thickness | 35 micron |
| Adhesive coat | 5 microns |
| Adhesion to substrate & differentially grated laminated film | 200 gm/cm |
| Adhesion of differentially grated laminated with scotch | passes |
| tape test: | |
| Thermoforming performance | Excellent |
| Impact strength | >950 g |
| Tensile strength | |
| Longitudinal | 15.1 kg/cm² |
| Transverse | 15.0 kg/cm² |
| Elongation | |
| Longitudinal | 6.2% |
| Transverse | 6.1% |

### Example 37

A laminate was produced as per example 33 except that the polymeric film was used from the class of co-polymer of polyethylene terepthalate and glycol (PETg) film of thickness 12 microns and pattern used for embossing was a square pattern. The laminate demonstrated the following properties

| Total thickness | 267 micron |
|---|---|
| Adhesion of non uniform embossed pattern | passes |
| with scotch tape test: | |
| Thermoforming performance | excellent |
| Impact strength | >950 g |
| Tensile strength | |
| Longitudinal | 6.5 kg/cm² |
| Transverse | 5.75 kg/cm² |
| Elongation | |
| Longitudinal | 5.5% |
| Transverse | 5.1% |

### Example 38

A laminate was produced as per example 33 except that a cast polypropylene film was used as a base having thickness of 300 microns and pattern used for embossing was a diamond pattern. The three layer laminate demonstrated the following properties

| Total thickness | 335 micron |
|---|---|
| Adhesion of non uniform embossed pattern | passes |
| with scotch tape test: | |
| Thermoforming performance | Excellent |
| Impact strength | >350 g |
| Tensile strength | |
| Longitudinal | 2.36 kg/cm2 |
| Transverse | 2.2 Kg/cm2 |
| Elongation | |
| Longitudinal | 11.2% |
| Transverse | 11% |

### Example 39

A film was produced as per example 33 except that the thickness of the PVC film was 35 microns and the pattern used was a broken glass pattern. The three layer film was further laminated with a 300 micron thick cast polypropylene film by using polyurethane based adhesive of thickness 5 microns with the help of gravure coating process. The resulting laminate demonstrated the following properties

| Total thickness | 340 micron |
|---|---|
| Adhesion of non uniform embossed pattern | passes |
| with scotch tape test: | |
| Thermoforming performance | Excellent |
| Impact strength | >953 g |
| Tensile strength | |
| Longitudinal | 17.39 kg/cm2 |
| Transverse | 16.78 Kg/cm2 |
| Elongation | |
| Longitudinal | 6.4% |
| Transverse | 6.5% |

### Example 40

A laminate was produced as per example 33 except thickness of the PVC film was 100 microns and pattern used was a broken glass pattern. The three layer film was further laminated with a 250 micron thick co-polymer of polyethylene terepthalate and glycol (PETg) film base using a polyurethane based adhesive with the help of gravure coating process. The resulting film demonstrated the following properties

| Total thickness | 360 micron |
|---|---|
| Adhesion of non uniform embossed pattern | passes |
| with scotch tape test: | |
| Thermoforming performance | Excellent |
| Impact strength | >953 g |
| Tensile strength | |
| Longitudinal | 17.39 kg/cm2 |
| Transverse | 16.78 Kg/cm2 |
| Elongation | |
| Longitudinal | 6.4% |
| Transverse | 6.5% |

### Example 41

A 50 micron pharmaceutical grade PVC film roll devoid of plasticizer having 600 mm width was subjected to un winder of gravure coating machine. A coloured lacquer was then applied to this film having thickness of 4 micron with the help of gravure technology then after second pass the Ester-acrylic based special primer from Magma Polymers Private Limited having viscosity of 26 to 32 sec. was applied using gravure roller to this PVC film and extra primer was removed by doctoring process. Deposition of this primer had a thickness of 0.8 microns. Then this film was allowed to travel through on line ovens via a conveyer at a temperature of 75° C. at the speed of 30 m/min The drying of the film was ensured by non tacky and non blocking rewinding at the rewinder roller.

Thus the two layer laminate film formed above was then transferred to a vacuum deposition machine. This machine had an in situ plasma device and was fitted with an evaporating boat in which the material to be deposited was placed. The primer coated surface of above laminated film was first treated with plasma and thereafter deposited with a zinc sulphide layer having 99.99% purity, thickness of this deposited layer was 0.020 microns. The thickness was achieved by adjusting the speed, height of gun and vacuum level.

Further, this three layer laminated film was exposed to differential embossing grating process. Custom made machine was used for embossing process. The three layered laminated film was then placed on un winder of this custom made machine, the film then was passed through a roller having temperature of 130 to 150° C. by which the film was getting soften, then diamond pattern shim was pressed on the metallized side of the laminate to create a diffraction grating on the film. The shim made for the above purpose was cut with a diamond pattern by using computerized laser cutting mechanism to avoid duplication of the pattern by any one else. Then this film was laminated to 200 micron PVC base devoid of plasticizer and having a vinyl chloride monomer concentration of less than 1 ppm and global migration less than 60 ppm.

Blister packs were formed from this film by thermoforming process which showed excellent thermoforming performance and showed a fine diamond non uniform embossed metallized pattern even after the thermoforming process. This laminate exhibited the following properties,

| | |
|---|---|
| Total thickness | 256 microns |
| Adhesion of non uniform embossed pattern | passes |
| with scotch tape test: | |
| Thermoforming performance | Excellent |
| Impact strength | 953 g |
| Tensile strength | |
| Longitudinal | 5.11 kg/cm2 |
| Transverse | 4.88 Kg/cm2 |
| Elongation | |
| Longitudinal | 5% |
| Transverse | 4.8% |
| Heat seal strength | 0.65 kg/cm |

### Example 42

Laminate made as per example 33 was coated with a PVDC coating on the other side of the diffraction grating with help of dispersion coating techniques to enhance the barrier properties of the laminate. The laminate exhibited the following properties,

| | |
|---|---|
| Total thickness | 280 micron |
| Adhesion of non uniform embossed pattern | passes |
| with scotch tape test: | |
| Thermoforming performance | Excellent |
| Impact strength | 953 g |
| Tensile strength | |
| Longitudinal | 5.11 kg/cm2 |
| Transverse | 4.88 Kg/cm2 |
| Elongation | |
| Longitudinal | 5% |
| Transverse | 4.8% |
| Heat seal strength | 0.65 kg/cm |
| WVTR | 0.1 gm/cm2/day |

### Example 43

A 50 micron pharmaceutical grade PVC film devoid of plasticizer and having vinyl monomer content less than 1 ppm and global migration less than 60 ppm was selected of 600 mm width. A roll of this film was loaded on gravure coating machine. Ester-acrylic based primer HT 07 XXX from Magma Polymers Private Limited with viscosity of 26 to 32 sec. was applied on one surface of the film using the gravure roller and extra primer was removed by doctoring process. 0.8 microns thick coating of this primer was achieved by adjusting the roller gap & doctor blade angle. Then this coated film was allowed to travel through on-line ovens via a conveyor. The oven temperature was set at a temperature of 75° C. and the speed of 30 m/min for drying the primer on the film. The drying of the primer on the film was confirmed by non tackiness and by non blocking of the said film at the rewinder roller.

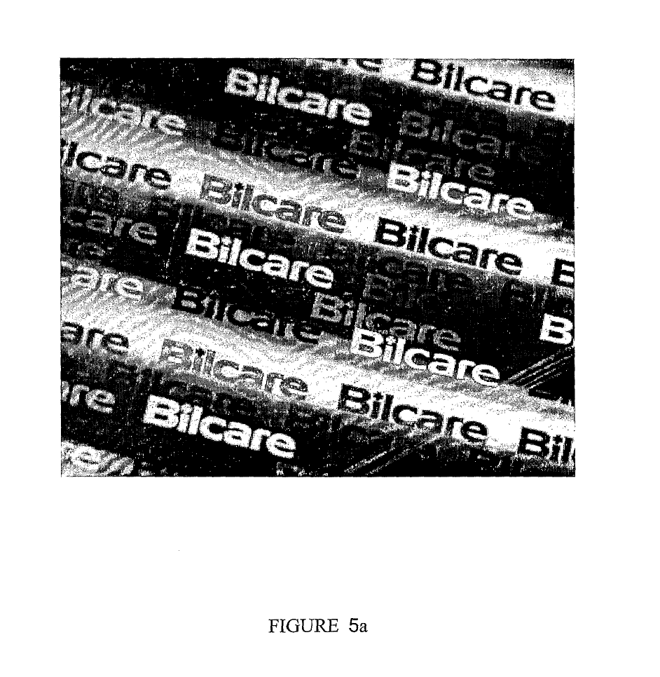

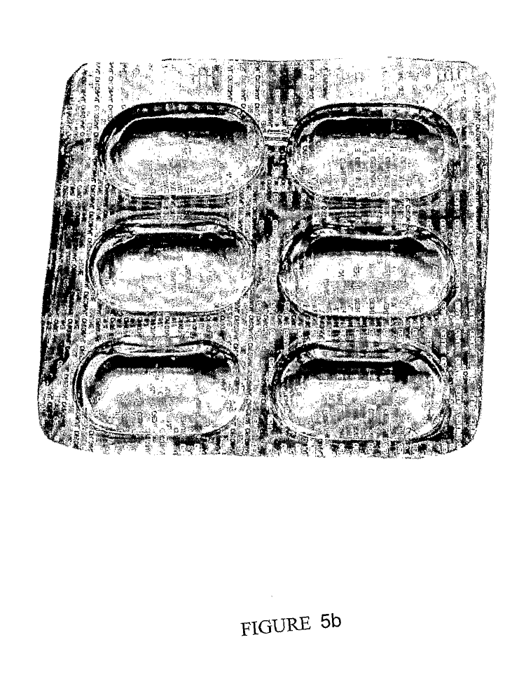

The two layer film formed by the above process was then transferred to a metallizer unit. This unit had an in situ plasma generation device and was fitted with an evaporation boat in which material [aluminum] to be deposited was placed. The primer coated surface of the film was treated by plasma and thereafter deposited with aluminum metal having 99.99% purity. Thickness of this deposited layer was 0.025 microns. The thickness was achieved by adjusting the speed, height of the gun and the vacuum level in the metallizer unit. This three layer film was exposed to a differential embossing grating process. A custom built machine was used for the embossing process. A diamond patterned shim was mounted on the roller which was preheated to a temperature of 130 to 150 degree Celsius. Movement of the shim with pressure on the metalized surface transferred the uneven impression of the pattern on metalized side of the said three layer film. This film there after was cooled down to 20 degree Celsius by passing over a chilled roller to fix the diamond pattern. The shim made for the above purpose was cut with a diamond pattern by using computerized laser cutting mechanism. A film with a refractive surface showing a differential grating pattern was produced. A multilayered differentially grated nonuniformly embossed film thus formed was then laminated with A 3-ply aluminum laminate film preferably of thickness 135 microns thick (PVC film 60 μm+Aluminium Foil 45 μm+Nylon film 25 μm) by a dry adhesion technology by using polyurethane adhesive of 4 micron thickness. The formed opaque multilayered flat film laminate with differential grated nonuniform embossed pattern is illustrated in FIG. 5a.

Blisters packs were formed from this multilayered laminate by cold forming process which showed excellent cold forming performance with fine diffraction grating pattern even after the cold forming process as shown in FIG. 5b. Specification of the film was as follows:

| Total thickness | about 190 micron |
|---|---|
| Adhesive coat | 4 gsm |
| Adhesion of differentially grated | passes |
| laminated with scotch tape test: | |
| Cold forming performance | Excellent Cold Formability |
| Tensile Strength | 675 kgf/sq.cm |
| Percentage Elongation | 16% |

### Example 44

A 50 micron pharmaceutical grade PVC film devoid of plasticizer and having vinyl monomer content less than 1 ppm and global migration less than 60 ppm was selected of 600 mm width. A roll of this film was loaded on gravure coating machine. Ester-acrylic based primer HT 07 XXX from Magma Polymers Private Limited with viscosity of 26 to 32 sec. was applied on one surface of the film using the gravure roller and extra primer was removed by doctoring process. 0.8 microns thick coating of this primer was achieved by adjusting the roller gap & doctor blade angle. Then this coated film was allowed to travel through on-line ovens via a conveyor. The oven temperature was set at a temperature of 75° C. and the speed of 30 m/min for drying the primer on the film. The drying of the primer on the film was confirmed by non tackiness and by non blocking of the said film at the rewinder roller.

The two layer film formed by the above process was then transferred to a metallizer unit. This unit had an in situ plasma generation device and was fitted with an evaporation boat in which material [zinc sulphide] to be deposited was placed. The primer coated surface of the film was treated by plasma and thereafter deposited with zinc sulphide having 99.99% purity. Thickness of this deposited layer was 0.025 microns. The thickness was achieved by adjusting the speed, height of the gun and the vacuum level in the metallizer unit.

This three layer film was exposed to a differential embossing grating process. A custom built machine was used for the embossing process. A diamond patterned shim was mounted on the roller which was preheated to a temperature of 130 to 150 degree Celsius. Movement of the shim with pressure on the metallized surface transferred the uneven impression of the pattern on metallized side of the said three layer film. This film there after was cooled down to 20 degree Celsius by passing over a chilled roller to fix the diamond pattern. The shim made for the above purpose was cut with a diamond pattern by using computerized laser cutting mechanism. A film with a refractive surface showing a diamond pattern was produced.
The multilayred differentially grated non uniform embossed film thus formed was laminated with a 3-ply aluminum laminate film of thickness 135 microns thick (PVC film 60 μm+Aluminium Foil 45 μm+Nylon film 25 μm) with dry adhesion technology using polyurethane adhesive of 4 micron thickness by gravure coating process.
Specification of the film was as follows:

| Total thickness | about 190 micron |
|---|---|
| Adhesive coat | 4 gsm |
| Adhesion of differentially grated | passes |
| laminated with scotch tape test: | |
| Cold forming performance | Excellent Cold Formability |
| Tensile Strength | 675 kgf/sq.cm |
| Percentage Elongation | 16% |

### Example 45

A 50 micron thick PVC substrate film of food and pharmaceutical grade, devoid of plasticizers having vinyl chloride monomer content less than 1 ppm and global migration of additives less than 60 ppm was laminated with a 3-ply aluminum base laminate film is of thickness 135 microns thick (PVC film 60 μm+Aluminium Foil 45 μm+Nylon film 25 μm) on nylon side by a dry adhesion process using polyurethane adhesive of 4 micron thickness by gravure coating process. A roll of this film was loaded on gravure coating machine. An Ester-acrylic based primer HT 07 XXX from Magma Polymers Private Limited with viscosity of 26 to 32 sec. was applied on opposite side of the substrate facing to nylon of the base film using the gravure roller and extra primer was removed by doctoring process. 0.8 microns thick coating of this primer was achieved by adjusting the roller gap & doctor blade angle. Then this coated film was allowed to travel through on-line ovens via a conveyer. The oven temperature was set at a temperature of 75° C. and the speed of 30 m/min for drying the primer on the film. The drying of the primer on the film was confirmed by non tackiness and by non blocking of the said film at the rewinder roller.

The multilayered film formed by the above process was then transferred to a metallizer unit. This unit had an in situ plasma generation device and was fitted with an evaporation boat in which material [aluminum] to be deposited was placed. The primer coated surface of the film was treated by plasma and thereafter deposited with aluminum metal having 99.99% purity. Thickness of this deposited layer was 0.025 microns. The thickness was achieved by adjusting the speed, height of the gun and the vacuum level in the metallizer unit.

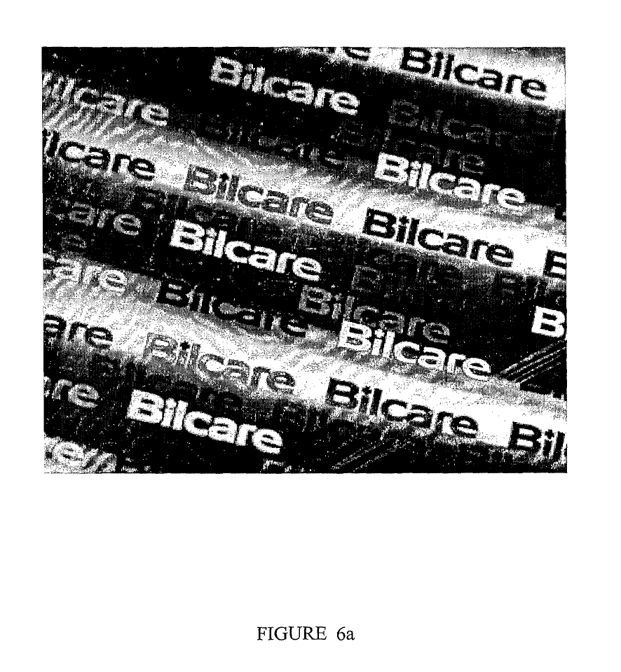

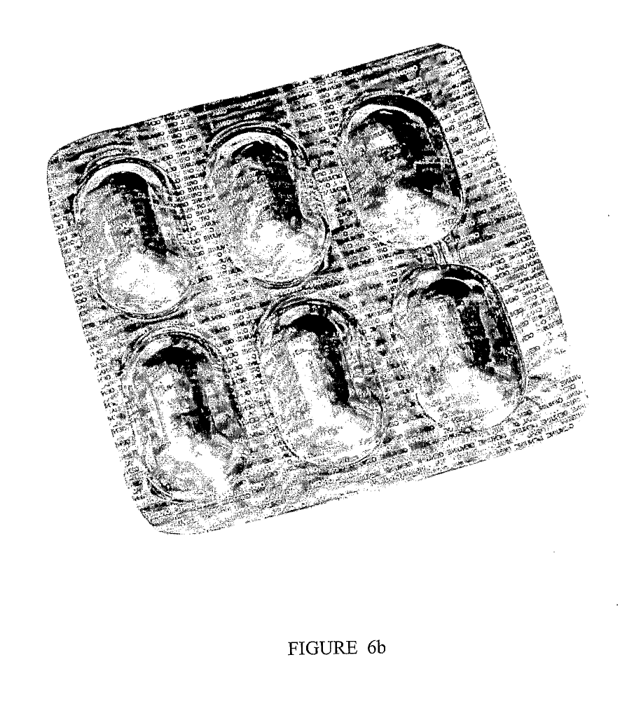

This multilayered film was exposed to a differential embossing grating process. A custom built machine was used for the embossing process. A differential grated patterned shim was mounted on the roller which was preheated to a temperature of 130 to 150 degree Celsius. Movement of the shim with pressure on the metalized surface transferred the uneven impression of the pattern on metalized side of the said three layer film. This film there after was cooled down to 20 degree Celsius by passing over a chilled roller to fix the diamond pattern. The shim made for the above purpose was cut with a differential grating pattern by using computerized laser cutting mechanism. A film with a refractive surface showing a differential grating pattern was produced. The formed opaque multilayered flat film laminate with differential grated nonuniform embossed pattern is illustrated in FIG. 6a.

Blisters packs were formed from this multilayered laminate by cold forming process which showed excellent cold forming performance with fine diffraction grating pattern even after the cold forming process as shown in FIG. 6b. Specification of the film was as follows:

| Total thickness | about 190 micron |
|---|---|
| Adhesive coat | 4 gsm |
| Adhesion of differentially grated | passes |
| laminated with scotch tape test: | |
| Cold forming performance | Excellent Cold Formability |
| Tensile Strength | 675 kgf/sq.cm |
| Percentage Elongation | 16% |

### Example 46

A 50 micron thick PVC substrate film of food and pharmaceutical grade, devoid of plasticizers having vinyl chloride monomer content less than 1 ppm and global migration of additives less than 60 ppm was laminated with a 3-ply aluminum base laminate film is of thickness 135 microns thick (PVC film 60 μm+Aluminium Foil 45 μm+Nylon film 25 μm) on nylon side by a dry adhesion process using polyurethane adhesive of 4 micron thickness by gravure coating process. A roll of this film was loaded on gravure coating machine. An Ester-acrylic based primer HT 07 XXX from Magma Polymers Private Limited with viscosity of 26 to 32 sec. was applied on opposite side of the substrate facing to nylon of the base film using the gravure roller and extra primer was removed by doctoring process. 0.8 microns thick coating of this primer was achieved by adjusting the roller gap & doctor blade angle. Then this coated film was allowed to travel through on-line ovens via a conveyer. The oven temperature was set at a temperature of 75° C. and the speed of 30 m/min for drying the primer on the film. The drying of the primer on the film was confirmed by non tackiness and by non blocking of the said film at the rewinder roller.

The multilayered film formed by the above process was then transferred to a metallizer unit. This unit had an in situ plasma generation device and was fitted with an evaporation boat in which material [zinc sulphide] to be deposited was placed. The primer coated surface of the film was treated by plasma and thereafter deposited with zinc sulphide having 99.99% purity. Thickness of this deposited layer was 0.025 microns. The thickness was achieved by adjusting the speed, height of the gun and the vacuum level in the metallizer unit.

This multilayered film was exposed to a differential embossing grating process. A custom built machine was used for the embossing process. A diamond patterned shim was mounted on the roller which was preheated to a temperature of 130 to 150 degree Celsius. Movement of the shim with pressure on the metalized surface transferred the uneven impression of the pattern on metalized side of the said three layer film. This film there after was cooled down to 20 degree Celsius by passing over a chilled roller to fix the diamond pattern. The shim made for the above purpose was cut with a diamond pattern by using computerized laser cutting mechanism. A film with a refractive surface showing a diamond pattern was produced. Specification of the film was as follows:

| Total thickness | about 190 micron |
|---|---|
| Adhesive coat | 4 gsm |
| Adhesion of differentially grated | passes |
| laminated with scotch tape test: | |
| Cold forming performance | Excellent Cold Formability |
| Tensile Strength | 675 kgf/sq.cm |
| Percentage Elongation | 16% |

While certain embodiments of the inventions have been described, these embodiments have been presented by way of example only, and are not intended to limit the scope of the inventions. Variations or modifications to the design and construction of this invention, within the scope of the invention, may occur to those skilled in the art upon reviewing the disclosure herein. Such variations or modifications are well within the spirit of this invention. The accompanying claims and their equivalents are intended to cover such forms or modifications as would fall within the scope and spirit of the invention.

1. A multilayer formable packaging film of total thickness not exceeding 1050 microns comprising
a substrate of thickness between 10 to 500 microns, that is devoid of plasticizer, wherein said substrate comprises at least one polymeric resin selected from the group of resins consisting of polyvinyl chloride (PVC), Polypropylene (PP), Polyethylene (PE), polyethylene terephthalate copolymerized with glycol (PETg) polyester, polyamide, polystyrene, copolymer of polystyerene and EVOH;
a coat of an ester acrylic based primer of thickness in the range of 0.1 to 1 micron, on a first surface of said substrate;
a metallized layer of non-uniform thickness between 0.001 to 0.3 micron deposited on said coat and embossed with a pre-determined pattern; and
a base selected from the group consisting of a transparent base, a translucent base and an opaque base of thickness between 50 to 1000 micron provided on the second surface of said substrate, wherein said base comprises at least one polymeric resin selected from a group of resins consisting of polyvinyl chloride (PVC), Polypropylene (PP), Polyethylene (PE), polyethylene terphthalate copolymerized with glycol (PETg), polyester, polyamide, polystyrene, copolymer of polystyerene and EVOH.

2. (canceled)

3. (canceled)

4. A multilayer formable packaging film as claimed in claim 1, wherein the substrate comprises a polyvinyl chloride film having vinyl monomer content less than 1 ppm and having a global migration of additives of less than 60 ppm.

5. (canceled)

6. A multilayer formable packaging film as claimed in claim 1, wherein the substrate has at least one layer.

7. A multilayer formable packaging film as claimed in claim 1, wherein the substrate is colored.

8. A multilayer formable packaging film as claimed in claim 1, wherein the substrate is multilayered and at least one of the layers is colored.

9. A multilayer formable packaging film as claimed in claim 1, wherein the metallized layer comprises at least one 99% pure metal selected from a group consisting of aluminum, gold, silver, copper and platinum.

10. (canceled)

11. (canceled)

12. A multilayer formable packaging film as claimed in claim 1, in which the base contains at least one layer.

13. (canceled)

14. A multilayer formable packaging film as claimed in claim 1, wherein the substrate and the base are integral and monolithic.

15. A multilayer formable packaging film as claimed in claim 1, wherein the substrate and the base are integral and multilayered.

16. A multilayer formable film as claimed in claim 1, wherein the base is multilayered and one of the layers of the multilayered base is pigmented.

17. A multilayer formable packaging material as claimed in claim 1, wherein the film optionally includes at least one colored lacquer layer having thickness of 0.5 to 8 microns applied one of between the substrate and the coat, between the coat and the metallized layer; and above the metallized layer.

18. A multilayer formable packaging material as claimed in claim 1, which includes a polymeric layer of thickness in the range of 0.5 to 250 microns, which has at least one property from a group of properties consisting of moisture barrier, oxygen barrier, gas barrier, or vapor barrier properties, said polymeric layer being located at least at one location operably within the substrate, on the substrate and below the coat, or below the substrate or on the metallized layer or within the base.

19. A multilayer formable packaging material as claimed in claim 1, which includes an anti-scuffing layer of thickness 0.5 to 250 microns provided on the top of the metallized layer wherein the anti-scuffing layer comprises anti-scuffing material selected from a group consisting of silica, molybdenum sulfide, graphite, and iron oxide.

20. A multilayer formable packaging material as claimed in claim 1, wherein the embossed pattern is selected from a group consisting of graphic pattern and textual pattern, wherein the graphic pattern is at least one selected from a group consisting of diamond pattern, a broken glass pattern, a rainbow pattern, a dot pattern, a square pattern, a honey comb pattern, a flower pattern, a triangular pattern, a wavy line pattern, a star burst pattern, a circular pattern, a striation pattern, and an image pattern.

21. A process for preparation of a multilayer formable packaging film of total thickness not exceeding 1050 microns, said process comprising the following steps:
i. selecting a substrate of thickness in the range of 10 to 1000 microns that is devoid of plasticizers;
ii. applying a coat of an ester acrylic based primer having thickness in the range of 0.1 to 1 micron on a first surface of the substrate;
iii. partially drying the coat;
iv. depositing a metallized layer on the partially dried coat;
v. embossing the metallized layer with a shim to form an embossed pattern thereon and make the thickness of the metallized layer non-uniform; and
vi. providing a base of thickness in the range of 50 to 1000 microns on the second surface of the substrate.

22. (canceled)

23. (canceled)

24. (canceled)

25. (canceled)

26. (canceled)

27. (canceled)

28. (canceled)

29. A process for preparation of a multilayer formable packaging film of total thickness not exceeding 1050 microns comprising the following steps:
i. selecting a substrate of thickness in the range of 10 to 1000 microns that is devoid of plasticizers;
ii. applying a coat of an ester acrylic based primer having thickness in the range of 0.1 to 1 micron on a first surface of the substrate;
iii. partially drying the coat;
iv. depositing a metallized layer on the partially dried coat;
v. embossing the metallized layer with a shim to form an embossed pattern thereon and make the thickness of the metallized layer non-uniform;
vi. providing a base of thickness in the range of 50 to 1000 microns in which aluminum foil is sandwiched between two polymeric films;
vii. applying the adhesive layer having thickness of about 2 to 8 microns to the base; and
viii. attaching the base to the substrate.

30. A process for preparation of a multilayer formable packaging film as claimed in claim 29, which includes at least one step selected from the group of steps consisting of:
applying a lacquer coat either on the substrate or on the coat or over the metallized layer or between substrate and base or below base,
forming the substrate by laminating at least two films together by solvent based adhesive lamination technique, thermal bonding or co extrusion and dry adhesion,
laminating the base either before or after the embossing step,
heating the shim between 90 to 150° C. and applying the heated shim to the metallized layer deposited on the film form an embossed pattern and immediately cooling the film with a pattern embossed thereon to around 20° C. and
providing an anti-scuffing layer on the embossed metallized layer.

31. A multilayer formable packaging film as claimed in claim 1, wherein base includes aluminum foil having thickness of about 20 to 150 microns sandwiched between two polymeric films to form a metal polymer laminate and an adhesive layer having thickness of about 2 to 8 microns for bonding the metal polymer based laminate to the substrate, said adhesive layer being selected from the group consisting of polyurethane, acrylic polymer, isocyanides and combination thereof.
